(19) United States
(12) Patent Application Publication
(10) Pub. No.: US 2012/0072693 A1
(43) Pub. Date: Mar. 22, 2012

(54) COMPUTER SYSTEM AND METHOD FOR MANAGING THE SAME

(75) Inventors: Mioko Mori, Yokohama (JP); Hirotaka Nakagawa, Sagamihara (JP)

(73) Assignee: HITACHI, LTD., Tokyo (JP)

(21) Appl. No.: 12/936,252

(22) PCT Filed: Sep. 22, 2010
(86) PCT No.: PCT/JP2010/005737

§ 371 Date: Oct. 4, 2010

(51) Int. Cl. G06F 12/00; G06F 12/02

(52) U.S. Cl. 711/165; 711/E12.002

(57) ABSTRACT

The present invention provides a technique capable of preventing data loss due to relocation of physical storage devices. When a request to relocate a logical storage area is issued, it is determined if the logical storage area to be relocated, which is composed of the physical storage devices in the source storage apparatus, can be configured in the destination storage apparatus, and if it is, the physical storage devices that constitute the logical storage area to be relocated are switched into a write-inhibit state in the source storage apparatus, and the write-inhibit state of the physical storage devices is maintained until the physical storage devices are set up and the logical storage area to be relocated is configured in the destination storage apparatus.

### TECHNICAL FIELD

The present invention relates to a computer system and a method for managing the computer system. For example, the invention relates to a process of relocating physical storage devices in a storage system.

### BACKGROUND ART

For computer systems having a storage apparatus, data migration techniques for migrating data stored in a physical storage device of the storage apparatus to a physical storage device of another storage apparatus have become increasingly important from the perspective of system operations. For example, when a storage apparatus is newly introduced, data may be migrated from a physical storage device of the old storage apparatus to a physical storage device of the new storage apparatus. In such a case, the physical storage device of the old storage apparatus after the data migration needs to be discarded or be used for a different purpose.

Meanwhile, there have been problems that, with an increase in the size of the physical storage device mounted on the storage apparatus, the time required to migrate the stored data could increase or the load on the computer system during the data migration could increase, which could result in degraded system performance.

In order to solve such problems, a conventional technique disclosed in Patent Literature 1, for example, proposes a method for continuously using part of the physical storage device of the old storage apparatus to migrate the whole data in the physical storage device without transferring the data to be migrated from the source storage apparatus to the destination storage apparatus.

Such a technique can meet a demand for continuously using, when a storage apparatus is newly introduced, part or whole of the physical storage device of the old storage apparatus that has been conventionally used.

### CITATION LIST

### Patent Literature

PTL 1: JP Patent Publication No. 2006-031367 A

### SUMMARY OF INVENTION

### Technical Problem

According to Patent Literature 1, it is possible to continuously use part of the physical storage device of the old storage apparatus without transferring data. However, there may be cases in which the relocation (migration) process fails with an erroneous translation of the configuration information of the physical storage device or an erroneous setup of the physical storage device in an unintended destination, or the set-up physical storage device may be used for a different purpose. When such a circumstance arises, data stored in the physical storage device of the old storage apparatus may be lost.

The present invention has been made in view of the foregoing circumstances, and provides a technique for preventing data loss due to relocation of physical storage devices.

### Solution to Problem

In order to solve the aforementioned problems, according to a computer system (a storage system) of the present invention, when a request to relocate a logical storage area is issued, it is determined if the logical storage area to be relocated, which is composed of the physical storage devices in the source storage apparatus, can be configured in the destination storage apparatus, and if it is, the physical storage devices that constitute the logical storage area to be relocated are switched into a write-inhibit state in the source storage apparatus, and the write-inhibit state of the physical storage devices is maintained until the physical storage devices are set up and the logical storage area to be relocated is configured in the destination storage apparatus.

That is, according to the present invention, when an instruction to initiate a process of relocating a physical storage device from a first storage apparatus (a source storage apparatus) to a second storage apparatus (a destination storage apparatus) is received, configuration information of the logical storage area to be relocated and the physical storage device in the first storage apparatus is acquired in the second storage apparatus. Then, management information (e.g., parity group configuration information and volume control information) of a logical storage area in the second storage apparatus is secured so that the logical storage area to be relocated can be configured in the second storage apparatus. Further, after the physical storage device to be relocated in the first storage apparatus is switched into a write-inhibit state, information indicating that the physical storage device to be relocated is removable from the first storage apparatus is issued.

Meanwhile, when attachment of the physical storage device to the second storage apparatus is detected, it is checked if the attached physical storage device is the physical storage device to be relocated from the first storage apparatus. If the attached physical storage device is the physical storage device to be relocated, a logical storage area is generated in the second storage apparatus using the secured management information. If the attached physical storage device is not the physical storage device to be relocated, the attached physical storage device is handled as a new physical storage device other than the physical storage device to be relocated.

Further, if the attached physical storage device is the physical storage device to be relocated, the attached physical storage device is switched into a write-enable state after a logical storage area is generated therein, and information indicating the completion of the relocation process is issued.

Further features of the present invention will become apparent from the following embodiments for implementing the present invention and the accompanying drawings.

### Advantageous Effects of Invention

According to the present invention, it is possible to avoid a circumstance that data may be lost when a physical storage device is relocated from a source storage apparatus to a destination storage apparatus.

### BRIEF DESCRIPTION OF DRAWINGS

FIG. 1 is a diagram showing the concept of a relocation process in a storage system of the present invention.

FIG. 2 is a diagram showing an exemplary schematic configuration of a storage system in accordance with the first embodiment of the present invention.

FIG. 3 is a block diagram showing an exemplary physical internal configuration of a storage apparatus in accordance with the present invention.

FIG. 4 is a diagram showing an exemplary logical configuration of local memory (LM) in a storage apparatus in accordance with the first embodiment of the present invention.

FIG. 5 is a diagram showing an exemplary configuration of a to-be-relocated parity group management table generated by an HDD relocation assistance program in accordance with the present invention.

FIG. 6 is a diagram showing an exemplary configuration of a to-be-relocated LBA correspondence table generated by an HDD relocation assistance program in accordance with the present invention.

FIG. 7 is a diagram showing an exemplary configuration of a configurable list of a configuration management program in accordance with the present invention.

FIG. 8 is a diagram showing an exemplary configuration of a to-be-access-inhibited HDD list generated by an HDD relocation assistance program in accordance with the present invention.

FIG. 9 is a diagram showing an exemplary configuration of a temporary configuration information table generated by an HDD relocation assistance program in accordance with the present invention.

FIG. 10 is a diagram showing an exemplary configuration of a temporary control information table generated by an HDD relocation assistance program in accordance with the present invention.

FIG. 11 is a flowchart (1) for illustrating a process of switching HDDs, which constitute a logical storage area to be relocated, into a write-inhibit state in accordance with the first embodiment of the present invention.

FIG. 12 is a flowchart (2) for illustrating a process of switching HDDs, which constitute a logical storage area to be relocated, into a write-inhibit state in accordance with the first embodiment of the present invention.

FIG. 13 is a flowchart (3) for illustrating a process of switching HDDs, which constitute a logical storage area to be relocated, into a write-inhibit state in accordance with the first embodiment of the present invention.

FIG. 14 is a flowchart (1) for illustrating a process of restoring a logical storage area to be relocated in the destination storage apparatus in accordance with the first embodiment of the present invention.

FIG. 15 is a flowchart (2) for illustrating a process of restoring a logical storage area to be relocated in the destination storage apparatus in accordance with the first embodiment of the present invention.

FIG. 16 is a flowchart (3) for illustrating a process of restoring a logical storage area to be relocated in the destination storage apparatus in accordance with the first embodiment of the present invention.

FIG. 17 is a flowchart for illustrating a process of inhibiting access to HDDs to be relocated in accordance with the first embodiment of the present invention.

FIG. 18 is a flowchart for illustrating a process of inhibiting the use of a reserved PG_ID for a different purpose in accordance with the first embodiment of the present invention.

FIG. 19 is a flowchart for illustrating a process of inhibiting the use of a reserved VOL_ID for a different purpose in accordance with the first embodiment of the present invention.

FIG. 20 is a diagram showing an exemplary GUI provided by an HDD relocation assistance program and configured to specify a management port of the source storage apparatus in accordance with the present invention.

FIG. 21 is a diagram showing an exemplary GUI provided by an HDD relocation assistance program and configured to select a parity group to be relocated in accordance with the present invention.

FIG. 22 is a diagram showing an exemplary schematic configuration of a storage system in accordance with the second embodiment of the present invention.

FIG. 23 is a block diagram showing an exemplary physical internal configuration of a service terminal in accordance with the second embodiment of the present invention.

FIG. 24 is a diagram showing an exemplary logical configuration of local memory (LM) in a storage apparatus in accordance with the second embodiment of the present invention.

FIG. 25 is a diagram showing an exemplary logical configuration of memory in a service terminal in accordance with the second embodiment of the present invention.

FIG. 26 is a flowchart (1) for illustrating a process of switching HDDs, which constitute a logical storage area to be relocated, into a write-inhibit state in accordance with the second embodiment of the present invention.

FIG. 27 is a flowchart (2) for illustrating a process of switching HDDs, which constitute a logical storage area to be relocated, into a write-inhibit state in accordance with the second embodiment of the present invention.

FIG. 28 is a flowchart (3) for illustrating a process of switching HDDs, which constitute a logical storage area to be relocated, into a write-inhibit state in accordance with the second embodiment of the present invention.

FIG. 29 is a flowchart (4) for illustrating a process of switching HDDs, which constitute a logical storage area to be relocated, into a write-inhibit state in accordance with the second embodiment of the present invention.

FIG. 30 is a flowchart (1) for illustrating a process of restoring a logical storage area to be relocated in the destination storage apparatus in accordance with the second embodiment of the present invention.

FIG. 31 is a flowchart (2) for illustrating a process of restoring a logical storage area to be relocated in the destination storage apparatus in accordance with the second embodiment of the present invention.

FIG. 32 is a flowchart (3) for illustrating a process of restoring a logical storage area to be relocated in the destination storage apparatus in accordance with the second embodiment of the present invention.

FIG. 33 is a flowchart for illustrating a process in which an HDD relocation assistance program monitors the destination storage apparatus and inhibits the use of a reserved PG_ID for a different purpose in accordance with the second embodiment of the present invention.

FIG. 34 is a flowchart for illustrating a process in which an HDD relocation assistance program monitors the destination storage apparatus and inhibits the use of a reserved VOL_ID for a different purpose in accordance with the second embodiment of the present invention.

FIG. 35 is a diagram showing an exemplary GUI provided by an HDD relocation assistance program and configured to specify a management port of the destination storage apparatus in accordance with second embodiment of the present invention.

### DESCRIPTION OF EMBODIMENTS

The present invention relates to a function for, when a storage device is physically relocated from a source storage apparatus to a destination storage apparatus, preventing data loss by protecting data stored in the storage device to be relocated.

Hereinafter, embodiments of the present invention will be described with reference to the accompanying drawings. It should be noted that the following embodiments are merely illustrative for the purpose of implementing the present invention, and thus are not intended to limit the technical scope of the present invention. Structures that are common throughout the drawings are assigned identical reference numbers.

In the following description, a “table” is used to manage information. However, such information need not necessarily be represented by a data structure of a table. For example, such information may be represented by a data structure of a list, DB, queue, or the like. That is, management of information does not depend on the data structure.

In describing the content of each information, expressions such as “identification information,” “identifier,” “name,” and “ID” can be used. Such expressions can be used interchangeably.

In the following description, each operation is described as being performed by a “program.” However, since it is only after a program is executed by a processor that the program can perform a given process using memory or a communication port (a communication control device), each operation can also be described as being performed by a processor. Further, a process disclosed as being performed by a program can also be performed by a computer or an information processing device. Further, part or the whole of a program can be implemented by dedicated hardware or be implemented as a module. A variety of programs can be installed on each computer via a program distribution server or a storage medium.

### (1) First Embodiment

### Concept of the Relocation Process

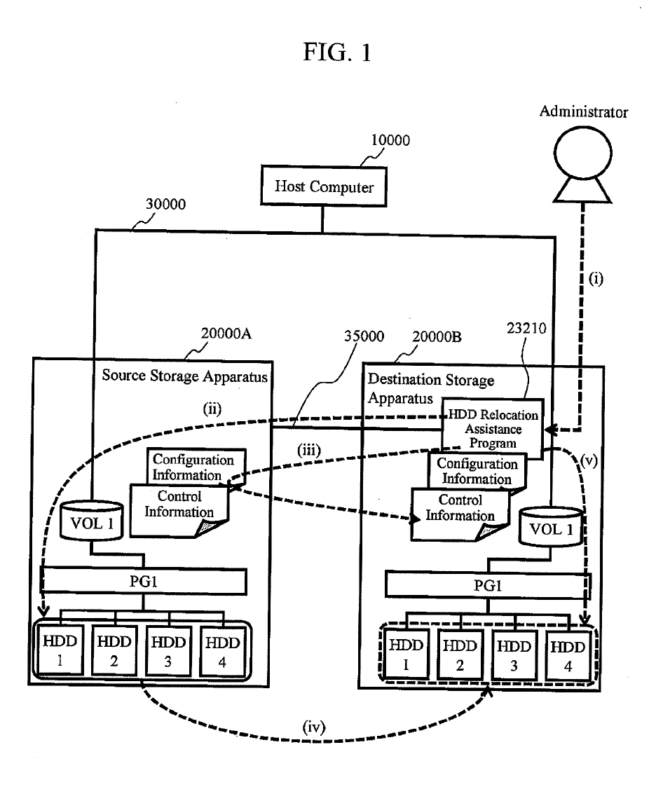

FIG. 1 is a diagram for illustrating a schematic concept of the process of relocating a physical storage device in accordance with the first embodiment of the present invention. In the first embodiment, when an HDD relocation assistance program 23210 of a destination storage apparatus 20000B receives an instruction from an administrator to relocate a logical storage area in a source storage apparatus 20000A while the logical storage area has data stored therein (flow (i)), the HDD relocation assistance program 23210 identifies HDDs (HDD1 to HDD4 in the example herein) that constitute a parity group to be relocated (flow (ii)), and acquires the control information and configuration information of the logical storage area and the HDDs in the source storage apparatus (flow (iii)).

Next, the HDD relocation assistance program 23210 checks if the logical storage area in the source storage apparatus can be configured in the destination storage apparatus 20000B, and if it is, translates the logical storage area in the acquired control information and configuration information into a logical storage area in the destination storage apparatus. At this time, the HDD relocation assistance program 23210 switches the HDDs, which have stored therein data of the logical storage area to be relocated, in the source storage apparatus into a write-inhibit state.

Then, the HDD relocation assistance program 23210, upon detecting that the HDDs have been set up in the destination storage apparatus 20000B (flow (iv)), extracts control information and configuration information on the detected HDDs from the translated control information and configuration information, configures a logical storage area on the basis of the extracted control information and configuration information, and releases the write-inhibit state of the HDDs (flow (v)).

The foregoing is the overview of the physical device relocation process. The details of the relocation process are described below. It should be noted that the processes described below are merely specific examples to help understand the present invention, and are not intended to limit the technical scope of the present invention.

<Configuration of the Computer System>

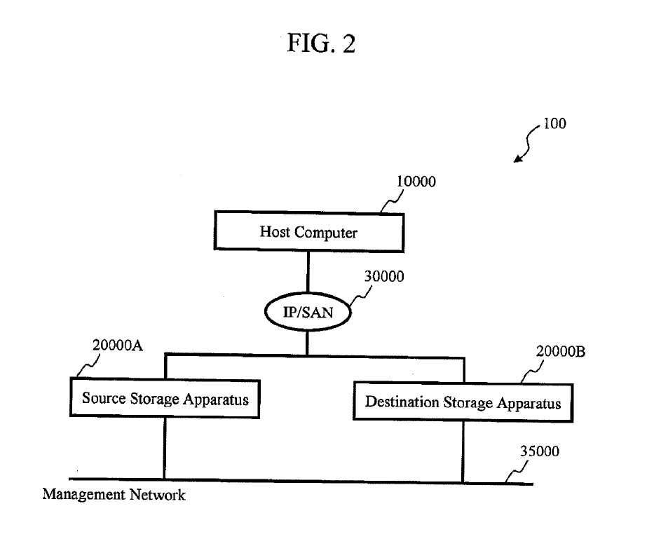

FIG. 2 is a block diagram showing an exemplary schematic configuration of the computer system 100 in accordance with the first embodiment of the present invention. The computer system 100 includes at least a single host computer 10000 and a plurality of storage apparatuses 20000 (the source storage apparatus 20000A and the destination storage apparatus 20000B). The host computer 10000 and the storage apparatus 20000 are connected via an IP/SAN 30000, and the storage apparatus 20000 provides a logical storage area (hereinafter also referred to as a “logical volume” or a “volume”) to the host computer 10000. The source storage apparatus 20000A and the destination storage apparatus 20000B are connected via a management network 35000 so that mutual communication between the systems is possible. The IP/SAN 30000 and the management network 35000 can be a common network.

<Configuration of the Storage Apparatus>

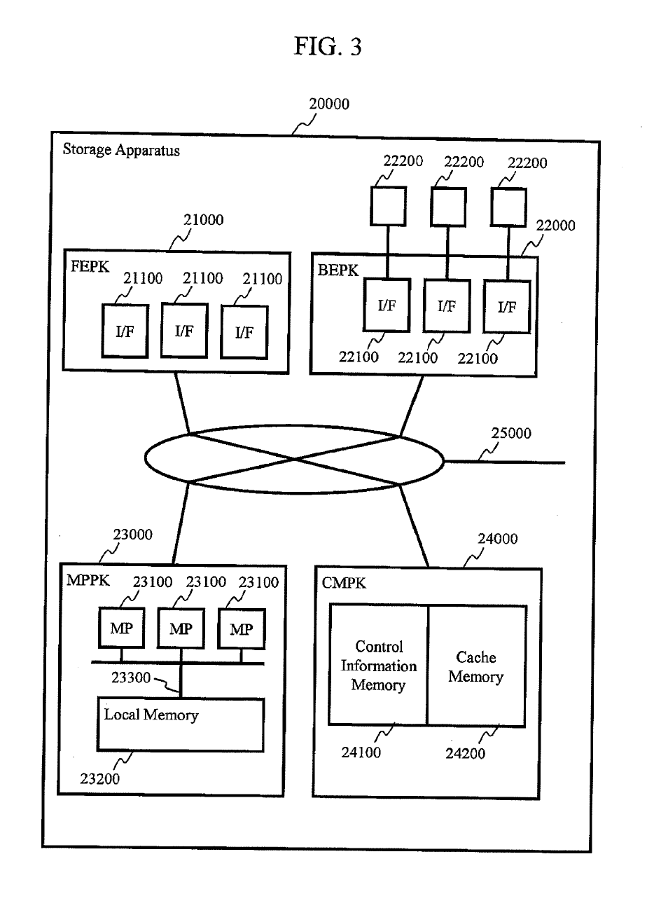

FIG. 3 is a diagram showing an exemplary internal configuration of the storage apparatus 20000 that can be applied to each of the source storage apparatus 20000A and the destination storage apparatus 20000B. The storage apparatus 20000 can include a display device for displaying a management GUI and a computer for executing various processes, though not shown.

The storage apparatus 20000 includes a host I/F part (FEPK: FrontEnd PacKage) 21000, a media I/F part (BEPK: BackEnd PacKage) 22000, a control device (MPPK: Micro Processor PacKage) 23000, and a shared-memory device (CMPK: Cache Memory PacKage) 24000, which are connected via an internal network 25000 so that mutual communication is possible.

The FEPK 21000 has a plurality of host I/Fs 21100, and is connected to the host computer 10000 via the IP/SAN 30000 (see FIG. 2), and is also connected to the internal network 25000 to mediate the transfer of data to be read or written between the host computer 10000 and the volume.

The BEPK 22000 has a plurality of media I/Fs 22100, and is connected to physical storage devices 22200 via cables, and is also connected to the internal network 25000 to mediate the transfer of data to be read or written between the internal network side and the physical storage devices 22200.

The CMPK 24000 has control information memory 24100 and data cache memory 24200. In the control information memory 24100, information necessary to perform a process such as control information and configuration information of the storage apparatus is stored. In the data cache memory 24200, data to be written to the physical storage devices 22200 or data read from the physical storage devices 22200 is temporarily stored (cached). The control information memory 24100 and the data cache memory 24200 may be volatile memory such as DRAM (Dynamic Random Access Memory).

The MPPK 23000 has a plurality of microprocessors (MPs) 23100 and local memory (LM) 23200 that are connected via a bus 23300. In the LM 23200, part of the control information stored in the control information memory 24100 is stored. The MP 23100 sets up a logical storage area (hereinafter also referred to as a “parity group”) composed of a set of a plurality of physical storage devices of the same type, cuts out part of the parity group as a volume, and provides it to the host computer 10000.

<Internal Logical Configuration of the Local Memory>

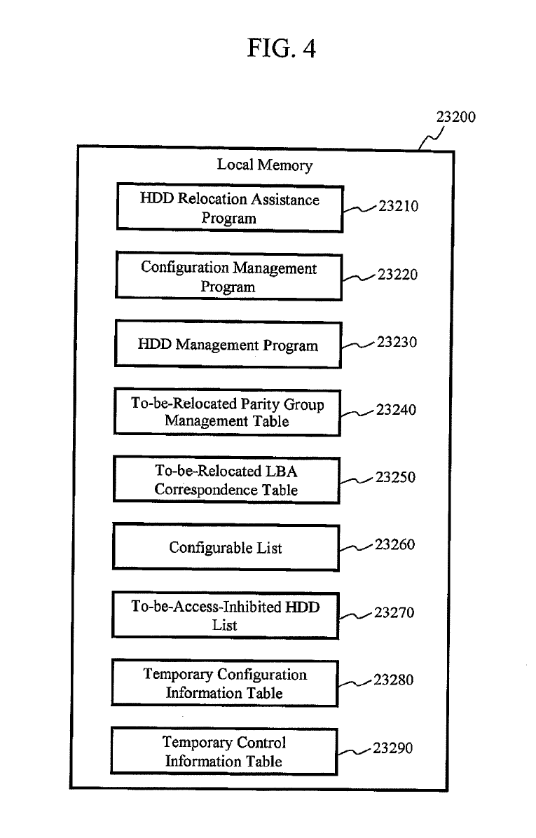

FIG. 4 is a diagram showing an exemplary internal logical configuration of the LM 23200 of the MPPK 23000, that is, exemplary configurations of various programs and information stored in the LM 23200.

The LM 23200 includes an HDD relocation assistance program 23210, a configuration management program 23220, an HDD management program 23230, a to-be-relocated parity group management table 23240, a to-be-relocated LBA correspondence table 23250, a configurable list 23260, a to-be-access-inhibited HDD list 23270, a temporary configuration information table 23280, and a temporary control information table 23290.

The HDD relocation assistance program 23210, upon receiving a request to relocate a parity group, acquires the configuration information and control information of the parity group to be relocated from the configuration management program 23220 of the source storage apparatus via the management network 35000, and generates the to-be-relocated parity group management table 23240 and the to-be-relocated LBA correspondence table 23250.

The HDD relocation assistance program 23210, when changing the configuration of the parity group in the source storage apparatus into a configuration in the destination storage apparatus, generates the temporary configuration information table 23280 and the temporary control information table 23290.

Further, the HDD relocation assistance program 23210 also has the configurable list 23260 of the storage apparatus, and uses the list to determine if the configuration of the parity group to be relocated can be configured in the storage apparatus.

The HDD relocation assistance support program 23210, when an HDD to be relocated that has no write-inhibit function is set up in the destination storage apparatus 20000B, generates the to-be-access-inhibited HDD list 23270 to inhibit access to the HDD to be relocated.

The HDD management program 23230 of the source storage apparatus 20000A, upon receiving an instruction from the HDD relocation assistance program 23210 of the destination storage apparatus 20000B to switch the HDD to be relocated that has a write-inhibit function into a write-inhibit state, switches the HDD into a write-inhibit state.

In addition, the HDD management program 23230, upon receiving an instruction from the HDD relocation assistance program 23210 to release the write-inhibit state of the HDD to be relocated, releases the write-inhibit state of the HDD.

<To-be-Relocated Parity Group Management Table>

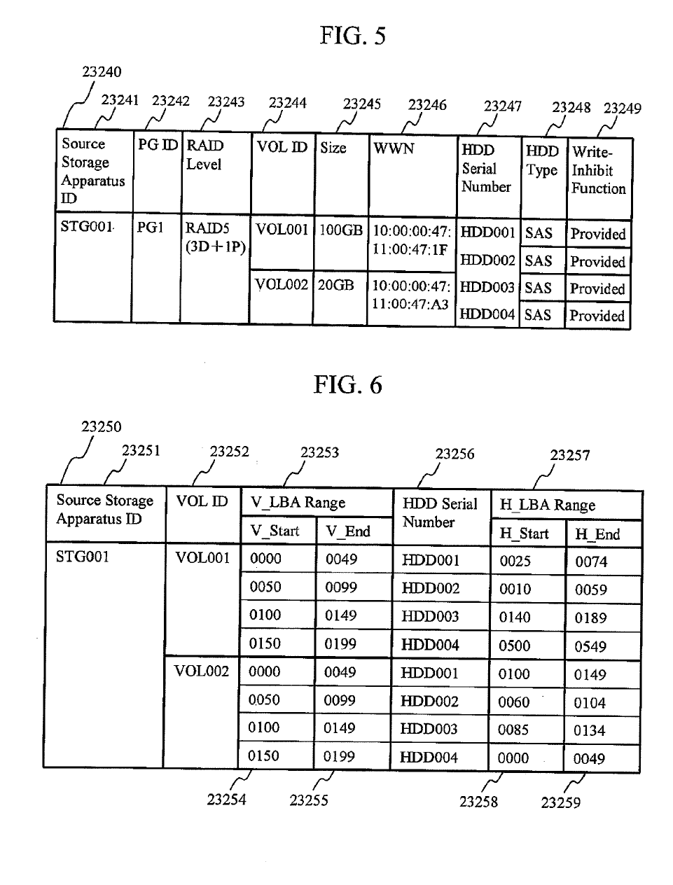

FIG. 5 is a diagram showing an exemplary configuration of the to-be-relocated parity group management table 23240 generated by the HDD relocation assistance program 23210.

The to-be-relocated parity group management table 23240 includes a source storage apparatus ID field 23241, a PG_ID field 23242, a RAID level field 23243, a VOL_ID field 23244, a size field 23245, a WWN field 23246, an HDD serial number field 23247, an HDD type field 23248, and a write-inhibit function field 23249.

The source storage apparatus ID field 23241 indicates the identifier for globally and uniquely identifying a source storage apparatus. The PG_ID field 23242 indicates the identifier for uniquely identifying a parity group in the source storage apparatus. The RAID level field 23243 indicates information representing the RAID level of the parity group. The VOL_ID field 23244 indicates the identifier for uniquely identifying a volume cut out of the parity group in the storage apparatus. The size field 23245 indicates information representing the size of the volume. The WWN field 23246 indicates information representing WWN (World Wide Name) that globally and uniquely identifies a host computer to which the volume is connected. The HDD serial number field 23247 indicates the identifier for globally and uniquely identifying HDDs that constitute the parity group. The HDD type field 23248 indicates information representing the type of the HDDs that constitute the parity group. The write-inhibit function field 23249 indicates information if the HDD has a write-inhibit function.

<To-be-Relocated LBA Correspondence Table>

FIG. 6 is a diagram showing an exemplary configuration of the to-be-relocated LBA correspondence table 23250 generated by the HDD relocation assistance program 23210.

The to-be-relocated LBA correspondence table 23250 includes a source storage apparatus ID field 23251, a VOL_ID field 23252, a V_LBA Range field 23253, an HDD serial number field 23256, and an H_LBA Range field 23257.

The source storage apparatus ID field 23251 indicates the identifier for globally and uniquely identifying a source storage apparatus. The VOL_ID field 23252 indicates the identifier for uniquely identifying a volume cut out of the relevant parity group in the storage apparatus. The V_LBA Range field 23253 indicates information including an V_Start field 23254 representing the start value of the range of the LBA (Logical Block Addressing) in which data of the volume is stored, and a V_End field 23255 representing the end value thereof. The HDD serial number field 23256 indicates the identifier for globally and uniquely identifying an HDD having stored therein data that is stored in the range of the LBA of the volume. The H_LBA Range field 23257 indicates information including an H_Start field 23258 representing the start value of the LBA of the HDD corresponding to the range of the LBA of the volume and an H_End field 23259 representing the end value of the LBA.

<Configurable List>

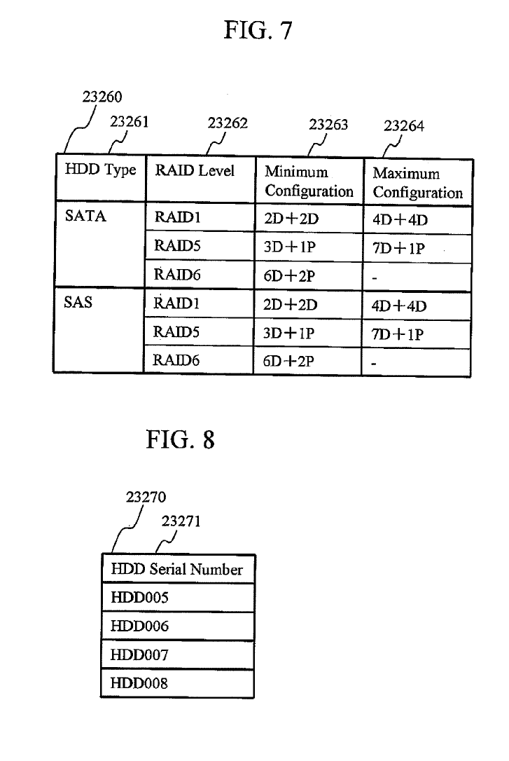

FIG. 7 is a diagram showing an exemplary configuration of the configurable list 23260 managed by the configuration management program 23220.

The configurable list 23260 includes an HDD type field 23261 indicating the type of a set-up HDD, a RAID level field 23262 indicating the RAID level that can be configured by an HDD of the relevant HDD type, a minimum configuration field 23263 indicating the minimum configuration of the RAID level that can be configured by an HDD of the relevant HDD type, and a maximum configuration field 23264 indicating the maximum configuration of the RAID level that can be configured by an HDD of the relevant HDD type.

<To-be-Access-Inhibited HDD List>

FIG. 8 is a diagram showing an exemplary configuration of the to-be-access-inhibited HDD list 23270 generated by the HDD relocation assistance program 23210. This list is initially empty because entry of information starts after a relocation process is initiated.

The to-be-access-inhibited HDD list 23270 includes an HDD serial number field 23271 indicating the identifier for globally and uniquely identifying an HDD that has no write-inhibit function and is to be access-inhibited.

<Temporary Configuration Information Table>

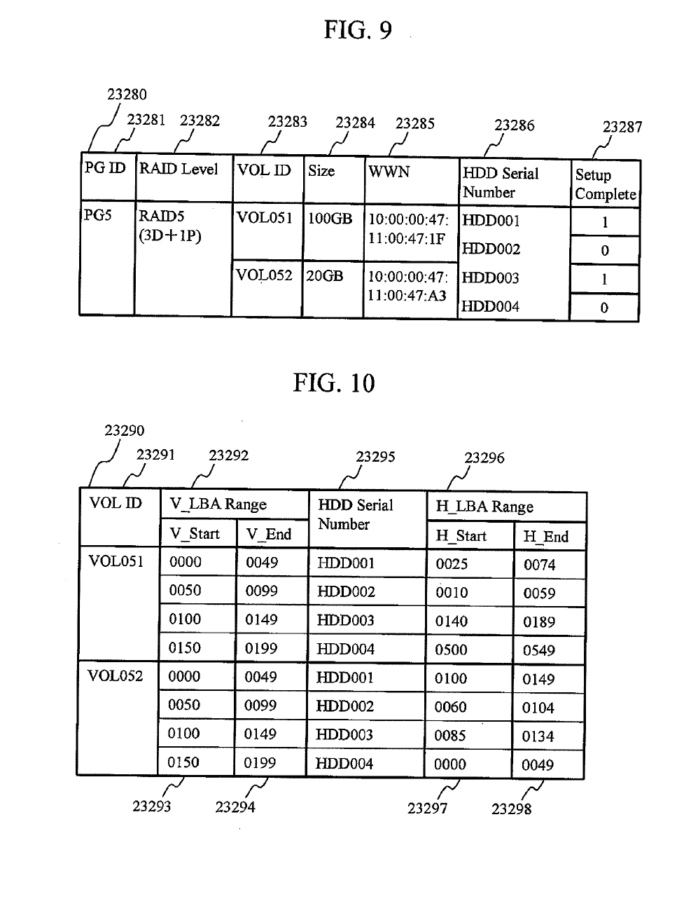

FIG. 9 is a diagram showing an exemplary configuration of the temporary configuration information table 23280. With the entry of each information in the table, when a parity group in the source storage apparatus 20000A is to be generated in the destination storage apparatus 20000B, generation of the parity group in the destination storage apparatus is reserved.

The temporary configuration information table 23280 includes a PG_ID field 23281 indicating the parity group ID of a parity group to be relocated from the source storage apparatus 20000A, in the destination storage apparatus 20000B, a RAID level field 23282 indicating the RAID level of the parity group, a VOL_ID field 23283 indicating the volume ID of a volume cut out of the parity group, in the destination storage apparatus, a size field 23284 indicating the size of the volume, a WWN field 23285 indicating WWN that can globally and uniquely identify a host to which the volume is connected, an HDD serial number field 23286 indicating the ID that can globally and uniquely identify HDDs that constitute the parity group, and a setup completion field 23287 indicating if the HDDs have been set up in the destination storage apparatus. It should be noted that a flag of the setup completion field 23287 indicates “zero” when reserved. Thus, FIG. 9 shows a state in which relocation is being gradually completed.

<Temporary Control Information Table>

FIG. 10 is a diagram showing an exemplary configuration of the temporary control information table 23290. With the entry of each information in the table, when each logical volume that constitutes a parity group in the source storage apparatus 20000A is to be generated in the destination storage apparatus, an address range for configuring a volume in the destination storage apparatus 20000B is reserved.

The temporary control information table 23290 includes a VOL_ID field 23291, a V_LBA Range field 23292, an HDD serial number field 23295, and an H_LBA Range field 23296.

The VOL_ID field 23291 indicates information of the volume ID of a parity group to be relocated in the destination storage apparatus 20000B. The V_LBA Range field 23292 indicates information including a V_Start field 23293 representing the start value of the range of the LBA (Logical Block Addressing) in which data of the volume is stored and a V_End field 23294 representing the end value of the LBA. The HDD serial number field 23295 indicates the identifier for globally and uniquely identifying an HDD having stored therein data that is stored in the range of the LBA of the volume. The H_LBA Range field 23296 indicates information including an H_Start field 23297 representing the start value of the LBA of the HDD corresponding to the range of the LBA of the volume and an H_End field 23298 representing the end value of the LBA.

<Process Performed before Removing Physical Storage Devices>

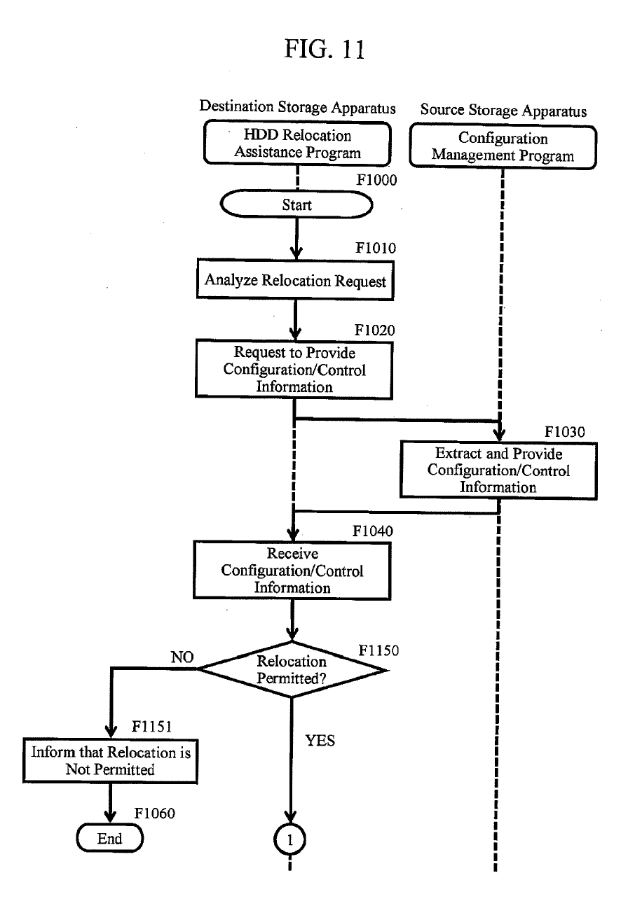

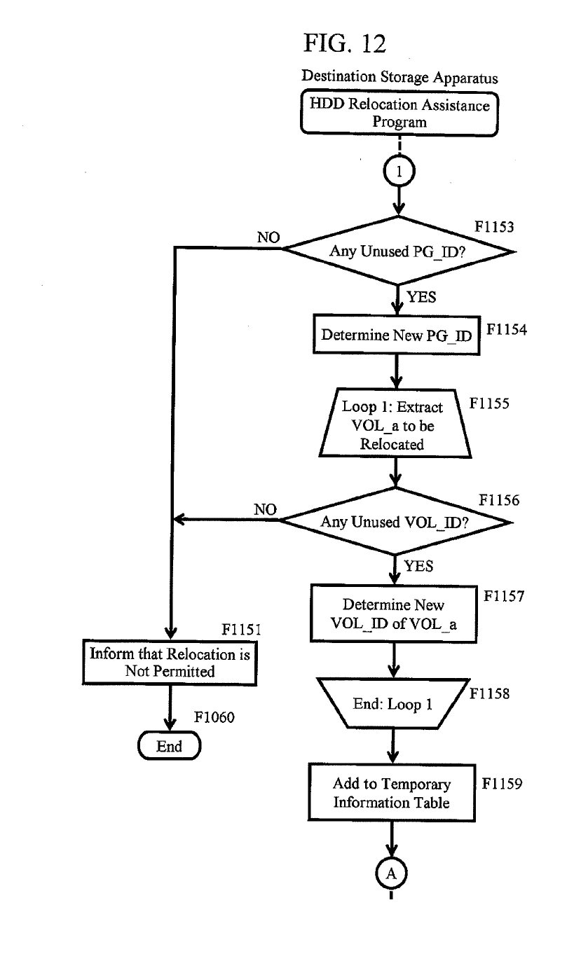

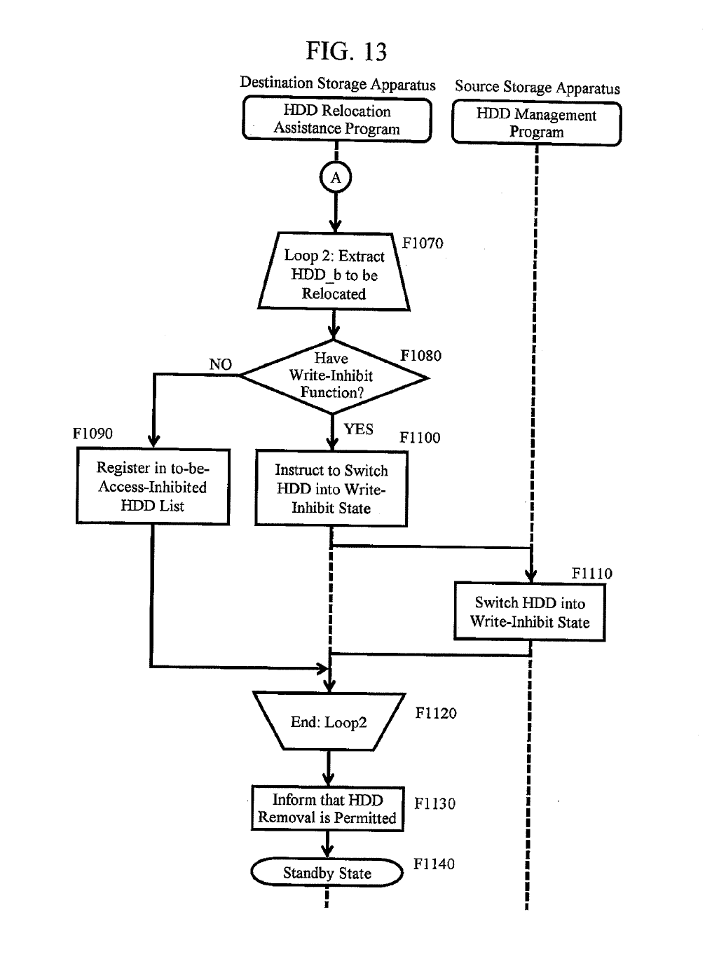

FIG. 11 to FIG. 13 are flowcharts for illustrating a process performed before removing physical storage devices from the source storage apparatus in accordance with the first embodiment of the present invention. By this process, HDDs to be relocated are allowed to be removed from the source storage apparatus 20000A.

The HDD relocation assistance program 23210 of the destination storage apparatus initiates the process upon receiving an entry from a user (administrator), which specifies the administrative IP address of the source storage apparatus 20000A and the parity group ID, via a GUI/CLI provided by the HDD relocation assistance program 23210 (F1000).

The HDD relocation assistance program 23210 analyzes the content of the relocation request entered by the user (F1010), and requests the configuration management program 23220 of the source storage apparatus 20000A to provide the configuration information and control information (F1020).

In response to the request from the HDD relocation assistance program 23210 of the destination storage apparatus 20000B to provide the information, the configuration management program 23220 of the source storage apparatus 20000A extracts the configuration information and control information and provides them (F1030).

Next, the HDD relocation assistance program 23210 of the destination storage apparatus 20000B registers the configuration information and control information, which have been received from the configuration management program 23220 of the source storage apparatus 20000A, in the to-be-relocated parity group management table 23240 and the to-be-relocated LBA correspondence table 23250 (F1040).

Next, the HDD relocation assistance program 23210 extracts the RAID configuration of the parity group to be relocated from the to-be-relocated parity group management table 23240, and compares the extracted RAID configuration with the configurable list 23260 to determine if the parity group to be relocated can be configured (F1150).

If it is determined that the parity group to be relocated cannot be configured in the destination storage apparatus 20000B (if the answer to F1150 is NO), the HDD relocation assistance program support program 23210 informs the user that relocation is not permitted by displaying such information on a display device, for example (F1151), and terminates the relocation process (process before the removal) (F1060). Meanwhile, if it is determined that the parity group to be relocated can be configured in the destination storage apparatus 20000B (if the answer to F1150 is YES), the HDD relocation assistance program 23210 determines the presence or absence of an unused PG_ID in the destination storage apparatus 20000B (F1153).

If an unused PG_ID is determined to be absent (if the answer to F1153 is NO), the HDD relocation assistance program 23210 informs the administrator that relocation is not permitted (F1151), and terminates the relocation process (process before the removal) (F1060). Meanwhile, if an unused PG_ID is determined to be present (if the answer to F1153 is YES), the HDD relocation assistance program 23210 determines it to be a new PG_ID of the parity group to be relocated (F1154).

Next, in Loop 1 from F1155 to F1158, the HDD relocation assistance program 23210 determines the VOL_ID of a volume cut out of the parity group to be relocated in the destination storage apparatus 20000B. Specifically, the HDD relocation assistance program 23210 extracts a single volume VOL_a cut out of the parity group to be relocated from the to-be-relocated parity group management table 23240 (F1155), and determines the presence or absence of an unused VOL_ID in the destination storage apparatus 20000B (F1156).

If an unused VOL_ID is determined to be absent (if the answer to F1156 is NO), the HDD relocation assistance program 23210 informs the administrator that relocation is not permitted, and terminates the relocation process (F1060). Meanwhile, if an unused VOL_ID is determined to be present (if the answer to F1156 is YES), the HDD relocation assistance program 23210 determines it to be a new VOL_ID of the VOL_a (F1157).

Then, the HDD relocation assistance program 23210 extracts a volume, which is registered in the to-be-relocated parity group management table 23240 and is not processed yet, as the VOL_a, and executes again the process of Loop 1 to all volumes registered in the to-be-relocated parity group management table 23240 (F1158).

Further, the HDD relocation assistance program 23210 extracts an HDD serial number and the like from the to-be-relocated parity group management table 23240 and the to-be-relocated LBA correspondence table 23250, and registers them in the temporary configuration information table 23280 and the temporary control information table 23290 (F1159). Accordingly, reservation of a parity group and volumes in the destination storage apparatus 20000B is completed.

Next, in Loop 2 from F1070 to F1120, the HDD relocation assistance program 23210 switches the HDDs to be relocated into a write-inhibit state or designates them as the targets to be access-inhibited. Specifically, the HDD relocation assistance program 23210 extracts an HDD_b as the HDD to be relocated from the to-be-relocated parity group management table 23240 (F1070), and determines if the HDD_b has a write-inhibit function (F1080).

If the extracted HDD_b has no write-inhibit function (if the answer to F1080 is NO), the HDD relocation assistance program 23210 registers the serial number of the HDD_b in the to-be-access-inhibited HDD list 23270 (F1090). Meanwhile, if the HDD_b has a write-inhibit function (if the answer to F1080 is YES), the HDD relocation assistance program 23210 instructs the HDD management program 23230 of the source storage apparatus 20000A to switch the HDD_b to be relocated into a write-inhibit state (F1100).

In accordance with the instruction from the HDD relocation assistance program 23210, the HDD management program 23230 of the source storage apparatus 20000A switches the HDD_b to be relocated into a write-inhibit state (F1110).

Then, assuming that HDD to be relocated selected in F1070 has been processed, the HDD relocation assistance program 23210 returns the process to F1070 (F1120).

In step F1070, the HDD relocation assistance program 23210 extracts an HDD to be relocated, which is registered in the to-be-relocated parity group management table 23240 and is not processed yet, as the HDD_b, and executes again the process of Loop 2 to all HDDs to be relocated that are registered in the to-be-relocated parity group management table 23240.

When the process of Loop 2 is complete, the HDD relocation assistance program 23210 informs the administrator that removal of the HDDs is permitted (e.g., displays such information on a display device (not shown)) (F1130), and sets the destination storage apparatus 20000B to a standby state to wait for the HDDs to be set up in (physically connected to) the destination storage apparatus 20000B (F1140).

Accordingly, it is possible to determine if relocation of a parity group to be relocated to the destination storage apparatus is permitted only by specifying the IP address of the source storage apparatus and the parity group to be relocated by a user, and to switch, if the relocation is determined to be permitted, the HDDs that constitute the parity group to be relocated into a write-inhibit state, so that the HDDs are allowed to be removed. Thus, it is possible to safely (while avoiding the danger of data loss) remove the HDDs to be relocated from the source storage apparatus 20000A.

<Process of Attaching the Physical Storage Devices>

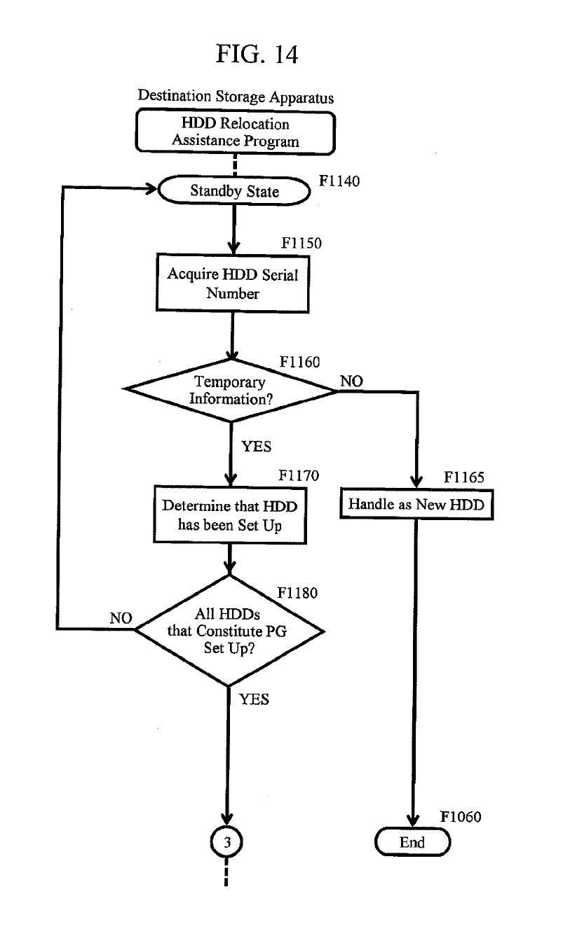

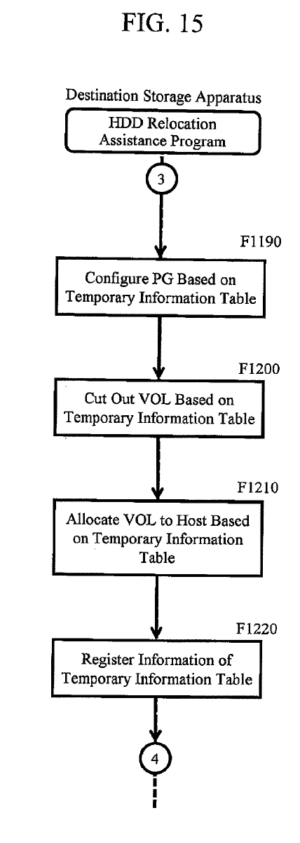

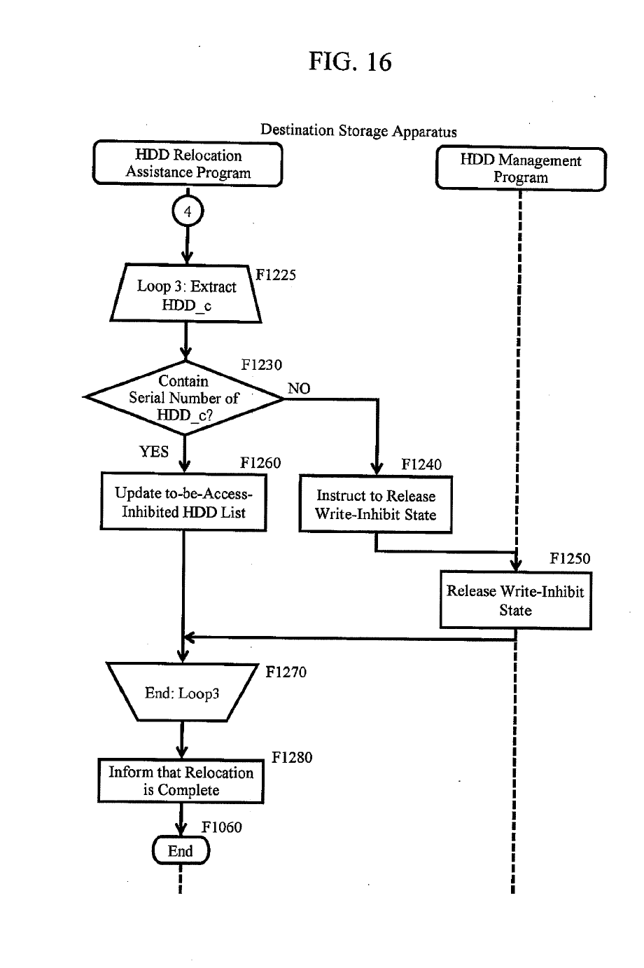

FIG. 14 to FIG. 16 are flowcharts for illustrating a process of setting up (attaching) the physical storage devices removed from the source storage apparatus 20000A in (to) the destination storage apparatus 20000B.

The HDD relocation assistance program 23210 of the destination storage apparatus 20000B, upon detecting that an HDD has been set up (attached), returns from the standby state (F1140). Then, the HDD relocation assistance program 23210 acquires a serial number of the set-up HDD (F1150), and determines if the HDD serial number field 23286 of the temporary configuration information table 23280 contains a matching HDD serial number (F1150). That is, the HDD relocation assistance program 23210 determines if the attached HDD corresponds to the HDD for which relocation has been reserved.

In step F1160, if the HDD serial number field 23286 of the temporary configuration information table 23280 is not determined to contain a HDD serial number that matches the acquired serial number (if the answer to F1160 is NO), the HDD relocation assistance program 23210 performs the process assuming that the attached HDD is a newly set-up HDD (F1165), and terminates the flow (F1060).

Meanwhile, if the HDD serial number field 23286 of the temporary configuration information table 23280 is determined to contain an HDD serial number that matches the acquired serial number (if the answer to F1160 is YES), the HDD relocation assistance program 23210 registers “1” in the setup completion field 23287 assuming that the attached HDD has been set up (F1170), and checks if all values in the setup completion field 23287 of the HDDs that constitute the relevant parity group are “1” (F1180).

If the setup completion field 23287 is determined to contain “0” which indicates the presence of an HDD that has not been set up (if the answer to F1180 is NO), that is, if not all of the HDDs to be relocated have been set up, the HDD relocation assistance program 23210 returns the process to a standby state.

Meanwhile, if all values in the setup completion field 23287 of the HDDs to be relocated are “1” (if the answer to F1180 is YES), that is, if all of the HDDs to be relocated have been set up, the HDD relocation assistance program 23210 configures a parity group in accordance with the temporary configuration information table 23280 (F1190). The ID of the parity group has been reserved as described earlier. Thus, the parity group is recognized in the destination storage apparatus 20000B on the basis of the ID.

Next, the HDD relocation assistance program 23210 cuts a volume out of the parity group in accordance with the temporary configuration information table 23280, and correlates the volume with the LBA of the HDDs in accordance with the temporary control information table 23290 (F1200). Further, the HDD relocation assistance program 23210 allocates the cutout volume to the WWN of the host computer 10000 in accordance with the temporary configuration information table 23280 (F1210). Upon completion of a series of the operations from F1190 to F1200, the HDD relocation assistance program 23210 registers the temporary configuration information and temporary control information in the actual control information and configuration information (not shown) that the configuration management program 23220 manages (F1220).

Next, in Loop 3 from F1225 to F1270, the HDD relocation assistance program 23210 executes a process of releasing the write-inhibit state of the HDDs to be relocated or removes the HDDs to be relocated from the targets to be access-inhibited. Specifically, the HDD relocation assistance program 23210 extracts an HDD_c to be relocated from the temporary configuration information table 23280 (F1125), and determines if the to-be-access-inhibited HDD list 23270 contains a serial number that matches the serial number of the HDD_c (F1230).

If the list is determined to contain no serial number that matches the serial number of the HDD_c (if the answer to F1230 is NO), the HDD relocation assistance program 23210 instructs the HDD management program 23230 to release the write-inhibit state of the HDD (F1240), so that the HDD management program 23230 releases the write-inhibit state of the HDD (F1250).

Meanwhile, if the list is determined to contain a serial number that matches the serial number of the HDD_c (if the answer to F1230 is YES), the HDD relocation assistance program 23210 deletes the serial number of the HDD from the to-be-access-inhibited HDD list 23270 and returns the process to step F1225 assuming that the HDD to be relocated selected in step F1225 has been processed (F1270).

In step F1270, the HDD relocation assistance program 23210 extracts an HDD to be relocated, which is registered in the temporary configuration information table 23280 and is not processed yet, as the HDD_c, and executes the process of Loop 3 to all HDDs to be relocated that are registered in the temporary configuration information table 23280.

When Loop 3 is complete, the HDD relocation assistance program 23210 informs the administrator of the completion of the relocation (F1280), and terminates the process (F1060). Examples of the methods for issuing information about the completion of the relocation include a method for displaying information about the completion of the relocation on a display device of the destination storage apparatus 20000B.

Accordingly, a configuration in the source storage apparatus can be relocated only by setting up the HDDs to be relocated in the destination storage apparatus by a user.

<Process of Inhibiting Access to the HDDs>

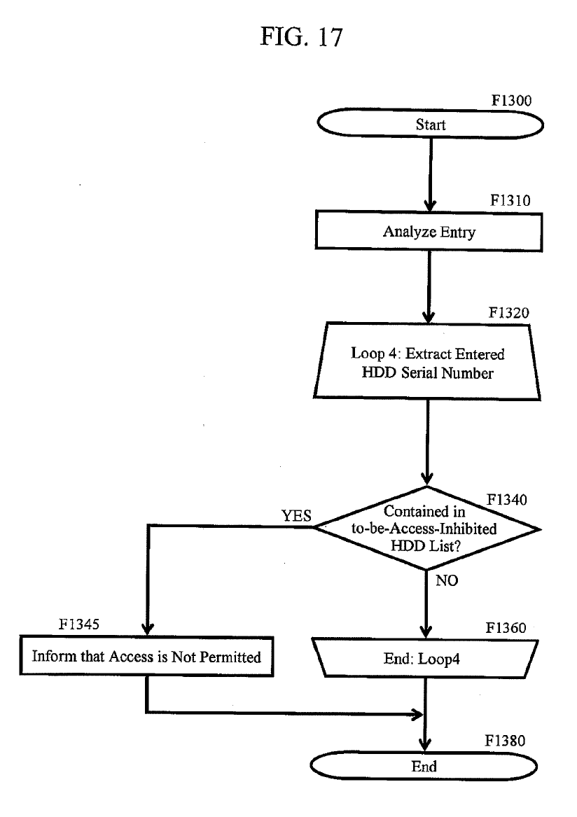

FIG. 17 is a flowchart for illustrating a process of inhibiting access to HDDs, which constitute the parity group to be relocated, in the storage apparatus in accordance with the present invention. This process is performed to inhibit access to the HDDs registered in the to-be-access-inhibited HDD list 23270 in the source storage apparatus 20000A and the destination storage apparatus 20000B, so that alteration of the data stored in the HDDs is prevented.

Specifically, when a process is initiated upon entry of an access request from a user (F1300), the configuration management program 23220 analyzes the entry from the user and acquires the serial number of the HDD to be accessed (F1310).

Next, in Loop 4 from F1320 to F1360, the HDD relocation assistance program 23210 accepts an inquiry from the configuration management program 23220 and determines if the to-be-access-inhibited HDD list 23270 contains the HDD to be accessed. Specifically, the HDD relocation assistance program 23210 extracts the serial number of the HDD to be accessed (F1320). Then, the HDD relocation assistance program 23210 determines if the to-be-access-inhibited HDD list 23270 contains the serial number of the HDD to be accessed (F1340).

If the to-be-access-inhibited HDD list 23270 is determined to contain the serial number of the HDD (if the answer to F1340 is YES), the HDD relocation assistance program 23210 informs that the HDD is not accessible (F1345), and terminates the process (F1380).

Meanwhile, if the HDD is not determined to be the target to be access-inhibited (if the answer to F1340 is NO), the HDD relocation assistance program 23210 returns the process to step F1320 assuming that the HDD to be accessed extracted in step F1320 has been processed (F1360).

The HDD relocation assistance program 23210 executes the process of Loop 4 to all HDDs to be accessed. When the process of Loop 4 has been executed to all HDDs that constitute the parity group to be relocated, the flow terminates (F1380).

Accordingly, access to the HDDs that constitute the parity group to be relocated can be inhibited, whereby loss of the data stored in the HDDs can be prevented.

<Process of Inhibiting the Use of a Reserved Parity Group ID>

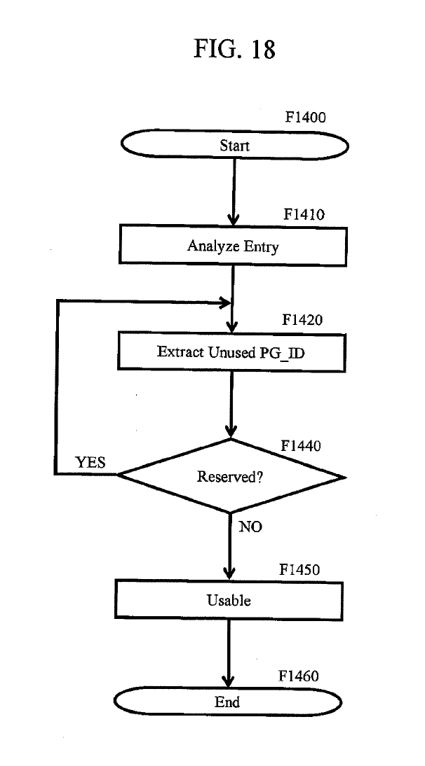

FIG. 18 is a flowchart for illustrating a process of inhibiting the use of a reserved parity group ID, which has been reserved in the destination storage apparatus 20000B for a parity group to be relocated, for a different purpose in accordance with the present invention.

When a process is initiated upon request from a user (administrator) to generate a new parity group (F1400), the configuration management program 23220 analyzes the entry from the user (F1410).

Next, the HDD relocation assistance program 23210, in response to an inquiry from the configuration management program 23220, determines if the parity group corresponding to the user's request can be configured. More specifically, the HDD relocation assistance program 23210 extracts an unused PG_ID (F1420), and compares the extracted unused PG_ID with the PG_ID field 23281 of the temporary configuration information table 23280 (F1440).

If a matching PG_ID is determined to exist (if the answer to F1440 is YES), the process returns to step F1420. Meanwhile, if a matching PG_ID is not determined to exist (If the answer to F1440 is NO), the HDD relocation assistance program 23210 recognizes that the extracted PG_ID is usable (F1450), and terminates the process (F1460).

<Process of Inhibiting the Use of a Reserved Volume ID>

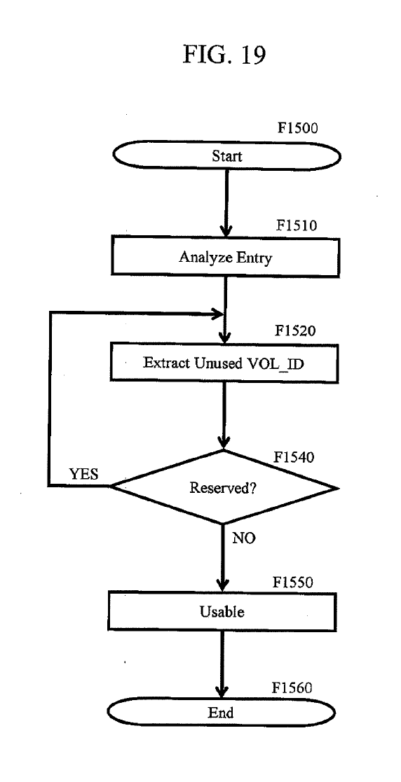

FIG. 19 is a flowchart for illustrating a process of inhibiting the use of a volume ID, which has been reserved in the destination storage apparatus 20000B for a volume that has been cut out of the parity group to be relocated, for a different purpose in accordance with the present invention.

When a process is initiated upon request from user (administrator) to generate a new volume (F1500), the configuration management program 23220 analyzes the entry from the user (F1510).

Next, the HDD relocation assistance program 23210, in accordance with an inquiry from the configuration management program 23220, determines if the volume corresponding to the user's request is usable. Specifically, the HDD relocation assistance program 23210 extracts an unused VOL_ID (F1520), and compares the extracted unused VOL_ID with the VOL_ID field 23283 of the temporary configuration information table 23280 (F1540).

If a matching VOL_ID is determined to exist (if the answer to F1540 is YES), the process returns to step F1520. Meanwhile, if a matching VOL_ID is not determined to exist (if the answer to F1540 is NO), the HDD relocation assistance program 23210 recognizes that the extracted VOL_ID is usable (F1550), and terminates the process (F1560).

Accordingly, it is possible to prevent the IDs, which are used for the parity group to be relocated and for a volume cut out of the parity group to be relocated, from being used for different purposes.

<GUI for the Relocation Process>

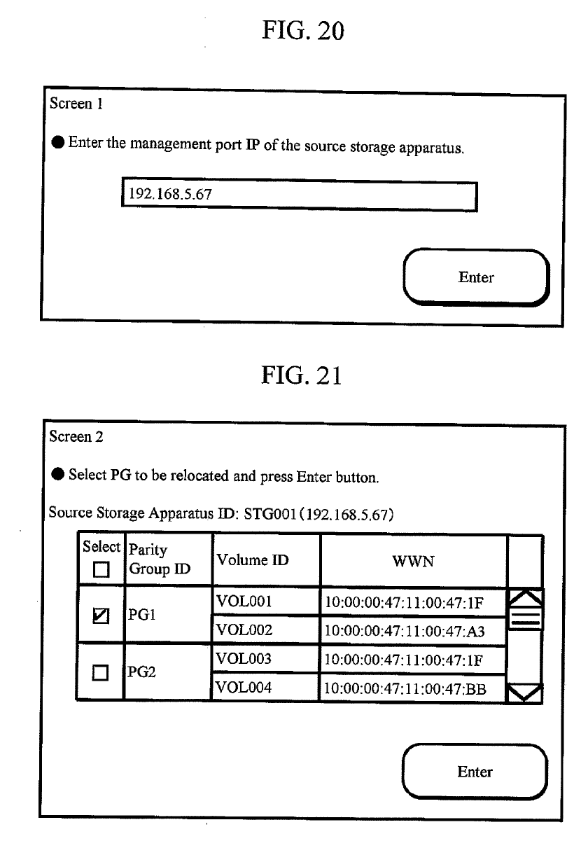

FIGS. 20 and 21 are diagrams showing exemplary GUIs used when a relocation process is executed. When executing a relocation process, a user (administrator) first enters the administrative IP address of the source storage apparatus 20000A (see FIG. 20).

Next, the HDD relocation assistance program 23210 of the destination storage apparatus 20000B, upon receiving the administrative IP address entered by the user, acquires the configuration information of the system from the configuration management program 23220 of the source storage apparatus 20000A via a management I/F of the source storage apparatus 20000A, and provides the information to the user.

Then, the display device of the destination storage apparatus 20000B displays the parity groups of the source storage apparatus 20000A on the basis of the provided configuration information, so that a user specifies a parity group to be relocated from among the displayed parity groups (see FIG. 21). In the example of FIG. 21, a parity group to be relocated is specified by checking a selection field. However, the present invention is not limited to such a method. For example, a parity group to be relocated can be specified by entering at least a single parity group ID among the displayed parity groups by typing.

### (2) Second Embodiment

In the second embodiment, the HDD relocation assistance program 23210 of a service terminal 40000 manages the relocation process. That is, the HDD relocation assistance program 23210 of the service terminal 40000, upon receiving an instruction to relocate a logical storage area in the source storage apparatus 20000A to the destination storage apparatus 20000B while the logical storage area has data stored therein, acquires the control information and configuration information of the logical storage area to be relocated and the HDDs from the configuration management program 23220 of the source storage apparatus 20000A via the management network 35000, and checks if the logical storage area to be relocated can be configured in the destination storage apparatus 20000B.

If it is determined that the logical storage area to be relocated can be configured in the destination storage apparatus 20000B, the HDD relocation assistance program 23210 translates the logical storage area corresponding to the acquired control information and configuration information into a logical storage area in the destination storage apparatus 20000B, and instructs the HDD management program 23230 of the source storage apparatus 20000A to switch the HDDs that have stored therein data of the logical storage area to be relocated into a write-inhibit state. In accordance with such instruction, the HDD management program 23230 of the source storage apparatus 20000A switches the HDDs to be relocated into a write-inhibit state.

In addition, the HDD relocation assistance program 23210 periodically inquires of the configuration management program 23220 of the destination storage apparatus 20000B for the presence or absence of a set-up HDD. Upon detecting a set-up HDD, the HDD relocation assistance program 23210 issues an instruction to configure a logical storage area on the basis of the translated control information and configuration information. In accordance with the instruction from the HDD relocation assistance program 23210, the configuration management program 23220 of the destination storage apparatus 20000B configures a logical storage area. Then, the HDD relocation assistance program 23210 issues an instruction to release the write-inhibit state of the newly set-up HDD, and in response, the HDD management program 23230 of the destination storage apparatus 20000B releases the write-inhibit state of the newly set-up HDD.

Hereinafter, the second embodiment will be described in detail.

<Configuration of the Computer System>

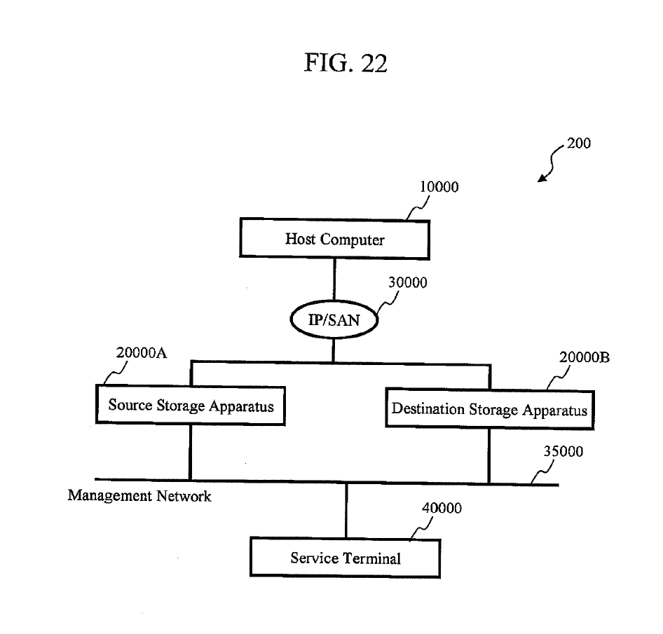

FIG. 22 is a diagram showing the schematic configuration of a computer system 200 in accordance with the second embodiment of the present invention.

The computer system 200 includes the host computer 10000, the source storage apparatus 20000A, the destination storage apparatus 20000B, and the service terminal 40000.

The host computer 10000 and the storage apparatus 20000 are connected via an IP/SAN 30000, and the storage apparatus 20000 (the source storage apparatus 20000A and the destination storage apparatus 20000B) provides a logical storage area (hereinafter also referred to as a “logical volume” or a “volume”) to the host computer 10000. The storage apparatus 20000 and the service terminal 40000 are connected via a management network 35000 so that mutual communication between the systems is possible. The IP/SAN 30000 and the management network 35000 can be a common network.

<Configuration of the Service Terminal>

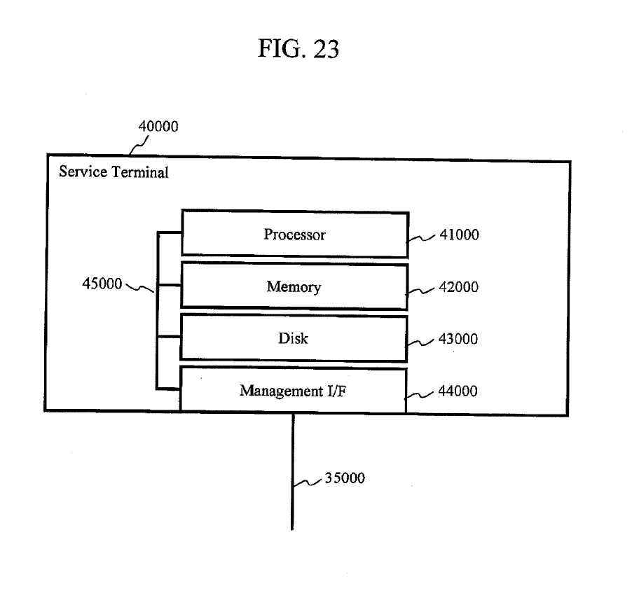

FIG. 23 is a diagram showing an exemplary configuration of the service terminal 40000 in accordance with the second embodiment. The service terminal 40000 includes a processor 41000, memory 42000, a disk 43000, and a management interface (I/F) 44000, which are connected via an internal network 45000 so that mutual communication is possible. The management I/F 44000 can communicate management information with the storage apparatus 20000 via the management network 35000.

<Local Memory Logical Configuration of the Storage Apparatus>

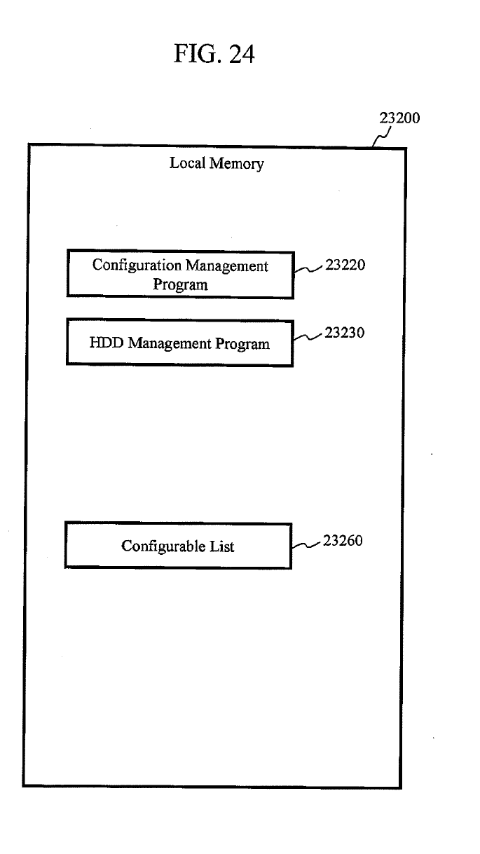

FIG. 24 is a diagram showing an exemplary logical configuration of the local memory (LM) 23200 of the MPPK 23000 in accordance with the second embodiment. It should be noted that the internal configuration of each of the storage apparatuses 20000A and 20000B is the same as that in the first embodiment (see FIG. 3).

The LM 23200 has stored therein a configuration management program 23220, an HDD management program 23230, and a configurable list 23260. The configuration management program 23220, in response to a request from the HDD relocation assistance program 23210 of the service terminal 40000, provides the configuration information and control information of a parity group to be relocated to the HDD relocation assistance program 23210. In addition, the HDD management program 23230, in response to a request from the HDD relocation assistance program 23210, provides the configurable list 23260 of the destination storage apparatus 20000B.

Further, the HDD management program 23230, when instructed by the HDD relocation assistance program 23210 to switch an HDD into a write-inhibit state, switches the HDD into a write-inhibit state. Meanwhile, the HDD management program 23230, when instructed by the HDD relocation assistance program 23210 to release the write-inhibit state of the HDD to be relocated, releases the write-inhibit state of the HDD.

<Memory Logical Configuration of the Service Terminal>

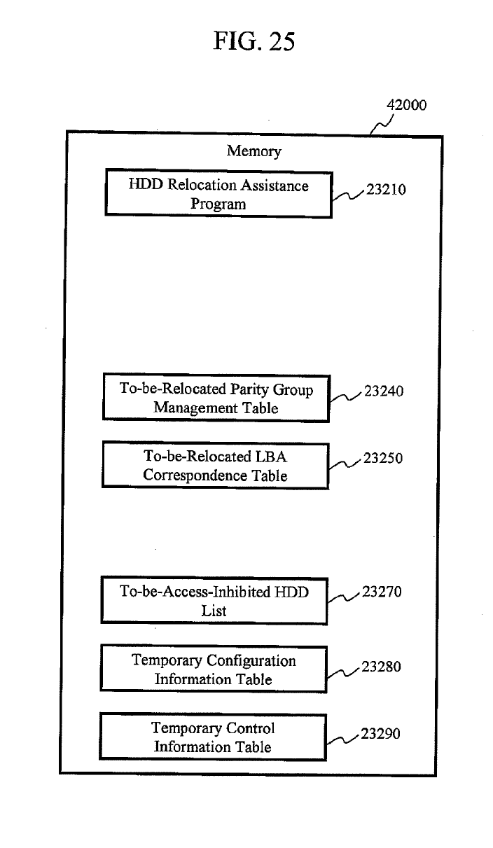

FIG. 25 is a diagram showing an exemplary logical configuration of the memory 42000 in the service terminal 40000. The memory 42000 includes as its logical configuration the HDD relocation assistance program 23210, the to-be-relocated parity group management table 23240, the to-be-relocated LBA correspondence table 23250, the to-be-access-inhibited HDD list 23270, the temporary configuration information table 23280, and the temporary control information table 23290.

The HDD relocation assistance program 23210, when requested by a user (administrator) to relocate a parity group, acquires the configuration information and control information of the parity group to be relocated from the configuration management program 23220 of the source storage apparatus 20000A via the management network 35000, and generates the to-be-relocated parity group management table 23240 and the to-be-relocated LBA correspondence table 23250.

In addition, the HDD relocation assistance program 23210, when an HDD to be relocated that has no write-inhibit function is set up in the destination storage apparatus 20000B, generates the to-be-access-inhibited HDD list 23270 to inhibit access to the HDD until the configuration is restored.

Further, the HDD relocation assistance program 23210, when changing the configuration of a parity group in the source storage apparatus 20000A into a configuration in the destination storage apparatus 20000B, generates the temporary configuration information table 23280 and the temporary control information table 23290.

<Process Performed before Removing Physical Storage Devices>

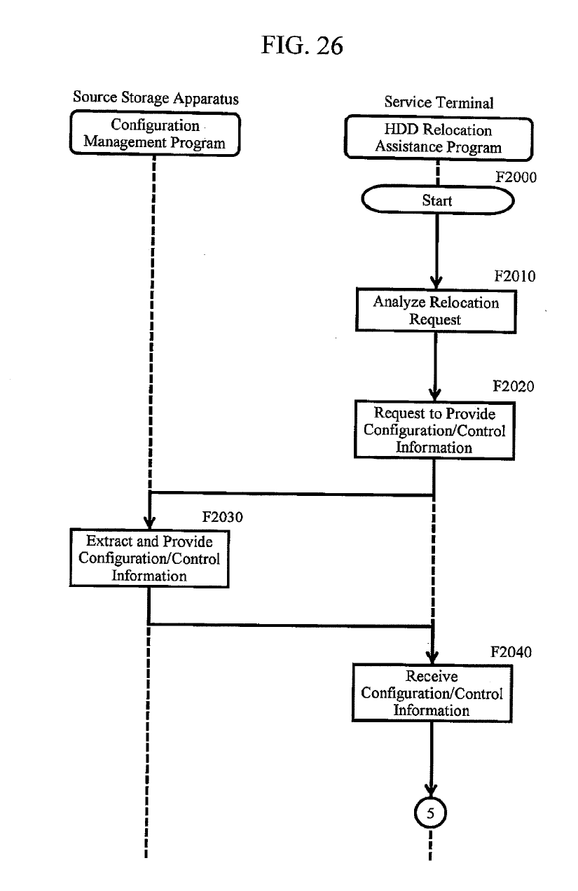

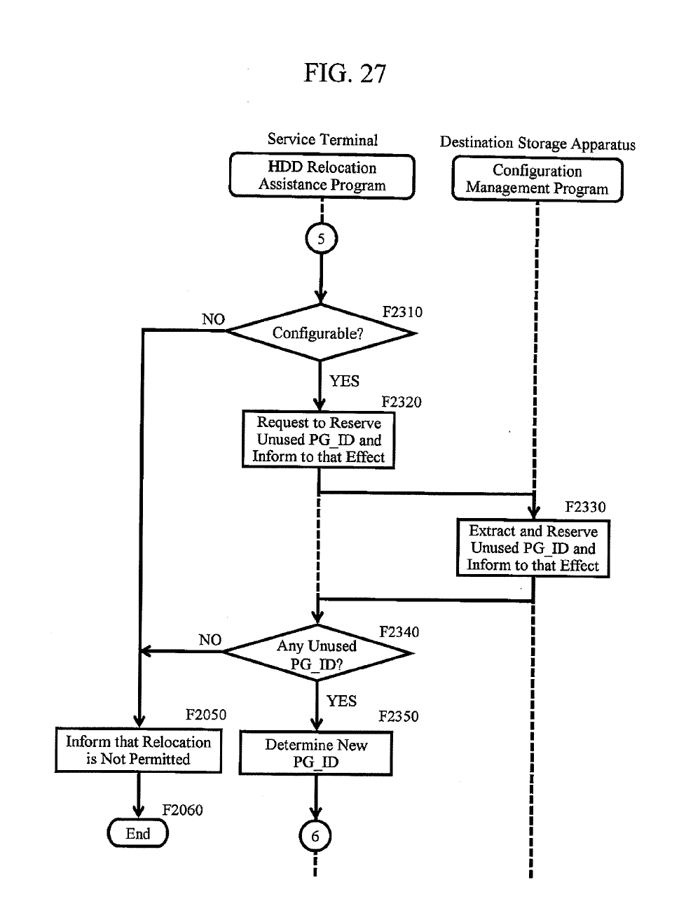

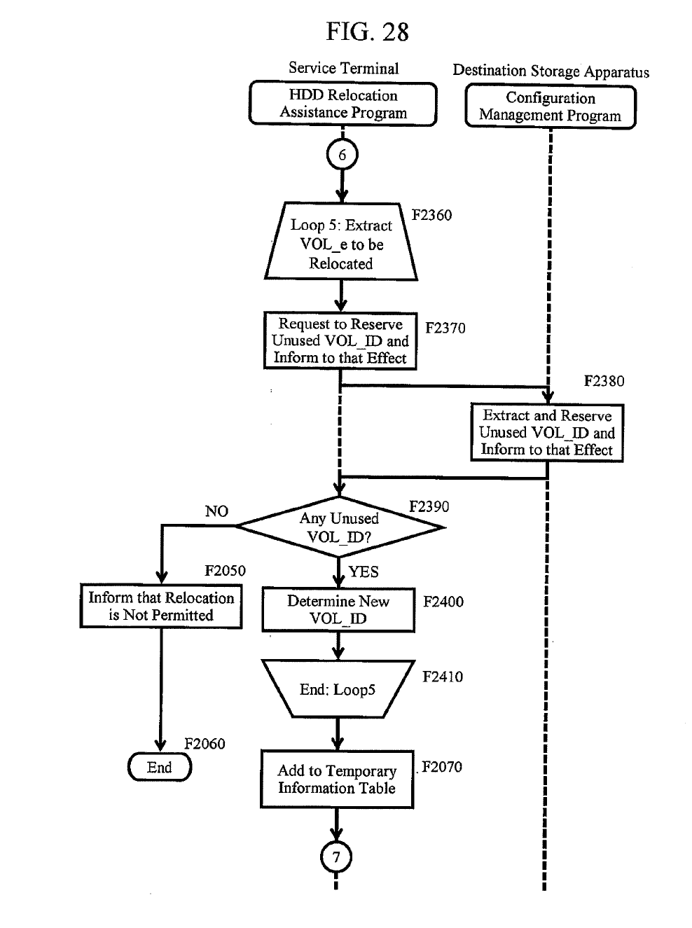

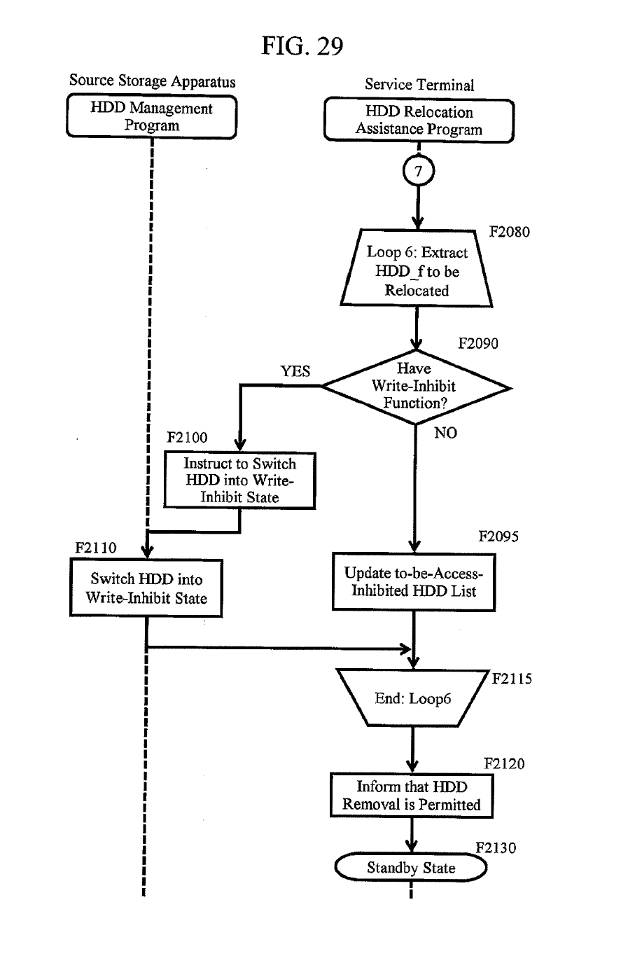

FIG. 26 to FIG. 29 are flowcharts for illustrating a process performed before removing physical storage devices from the source storage apparatus in accordance with the second embodiment of the present invention.

A process of relocating physical storage devices in accordance with this embodiment is initiated when a user (administrator) issues a relocation request by specifying the management port IP address of the source storage apparatus 20000A, the ID that uniquely identifies a parity group to be relocated in the source storage apparatus 20000A, and the management port IP address of the destination storage apparatus 20000B using a GUI/CLI provided by the HDD relocation assistance program 23210 of the service terminal 40000 (F2000).

The HDD relocation assistance program 23210 analyzes the entry from the user (F2010) and requests the configuration management program 23220 of the source storage apparatus 20000A to provide the control information and configuration information of the parity group to be relocated (F2020).

The configuration management program 23220 of the source storage apparatus 20000A extracts the control information and configuration information of the parity group to be relocated, and provides them to the HDD relocation assistance program 23210 of the service terminal 40000 (F2030).

The HDD relocation assistance program 23210 registers the configuration information and control information, which have been received from the configuration management program 23220 of the source storage apparatus 20000A, in the to-be-relocated parity group management table 23240 and the to-be-relocated LBA correspondence table 23250 (F2040).

Next, the HDD relocation assistance program 23210 extracts the RAID configuration of the parity group to be relocated from the to-be-relocated parity group management table 23240, and compares it with the configurable list 23260 (F2310).

If it is determined that the parity group to be relocated cannot be configured in the destination storage apparatus 20000B (if the answer to F2310 is NO), the HDD relocation assistance program 23210 informs the user that relocation is not permitted by displaying a message to that effect on the display screen, for example (F2050), and terminates the process (F2060).

Meanwhile, if it is determined that the parity group to be relocated can be configured in the destination storage apparatus (if the answer to F2310 is YES), the HDD relocation assistance program 23210 requests the configuration management program 23220 of the destination storage apparatus 20000B to reserve an unused PG_ID in the destination storage apparatus 20000B and inform to that effect (F2320). In response, the configuration management program 23220 extracts and reserves an unused PG_ID and informs the HDD relocation assistance program 23210 to that effect (F2330). If there is no unused PG_ID, the configuration management program 23220 informs the HDD relocation assistance program 23210 to that effect.

The HDD relocation assistance program 23210 determines the presence or absence of an unused PG_ID from the information provided by the configuration management program 23220 (F2340). If an unused PG_ID is determined to be absent (if the answer to F2340 is NO), the HDD relocation assistance program 23210 informs the user that relocation is not permitted (F2050) and terminates the process (F2060). If an unused PG_ID is determined to be present (if the answer to F2340 is YES), the HDD relocation assistance program 23210 determines it to be a new PG_ID of the parity group to be relocated (F2350).

Next, in Loop 5 from F2360 to F2410, the HDD relocation assistance program 23210 determines the VOL_ID of a volume cut out of the parity group to be relocated in the destination storage apparatus 20000B. Specifically, the HDD relocation assistance program 23210 extracts a VOL_e cut out of the parity group to be relocated from the to-be-relocated parity group management table 23240 (F2360), and requests the configuration management program 23220 to reserve an unused VOL_ID in the destination storage apparatus 20000B and inform to that effect (F2370). In response to the request, the configuration management program 23220, in the absence of an unused VOL_ID, informs the HDD relocation assistance program 23210 to that effect, and in the presence of an unused VOL_ID, extracts and reserves the VOL_ID and informs the HDD relocation assistance program 23210 to that effect (F2380).

The HDD relocation assistance program 23210 determines the presence or absence of an unused VOL_ID on the basis of the information provided by the configuration management program 23220 (F2390). If an unused VOL_ID is determined to be absent (if the answer to F2390 is NO), the HDD relocation assistance program 23210 informs the user that relocation is not permitted (F2050) and terminates the process (F2060). Meanwhile, if an unused VOL_ID is determined to be present (If the answer to F2390 is YES), the HDD relocation assistance program 23210 determines it to be a new PG_ID of the parity group to be relocated (F2400).

In step F2410, the HDD relocation assistance program 23210 again extracts a volume, which is registered in the to-be-relocated parity group management table 23240 and is not processed yet, as the VOL_e, and executes the process of Loop 5 to all volumes registered in the to-be-relocated parity group management table 23240.

Thereafter, the HDD relocation assistance program 23210 extracts an HDD serial number and the like from the to-be-relocated parity group management table 23240 and the to-be-relocated LBA correspondence table 23250, and registers them in the temporary configuration information table 23280 and the temporary control information table 23290 (F2070).

Next, in Loop 6 from F2080 to F2115, the HDD relocation assistance program 23210 switches the HDDs to be relocated into a write-inhibit state or designates them as the targets to be access-inhibited. Specifically, the HDD relocation assistance program 23210 extracts an HDD_f to be relocated from the to-be-relocated parity group management table 23240 (F2080), and determines if the HDD_f has a write-inhibit function (F2090).

If the HDD_f is determined to have no write-inhibit function (if the answer to F2090 is NO), the HDD relocation assistance program 23210 registers the serial number of the HDD_f in the to-be-access-inhibited HDD list 23270 (F2095). Meanwhile, if the HDD_f is determined to have a write-inhibit function (if the answer to F2090 is YES), the HDD relocation assistance program 23210 instructs the HDD management program 23230 of the source storage apparatus 20000A to switch the HDD_f into a write-inhibit state (F2100).

In accordance with the instruction from the HDD relocation assistance program 23210, the HDD management program 23230 switches the HDD_f into a write-inhibit state (F2110).

Then, assuming that the HDD to be relocated selected in step F2080 has been processed, the HDD relocation assistance program 23210 returns the process to step F2080 (F2115). In F2080, an HDD to be relocated, which is registered in the to-be-relocated parity group management table 23240 and is not processed yet, is extracted as the HDD_f, and the process of Loop 6 is executed to all HDDs to be relocated that are registered in the to-be-relocated parity group management table 23240.

When Loop 6 is complete, the HDD relocation assistance program 23210 informs the user that removal of the HDDs is permitted (F2120), and enters a standby state to wait for the HDDs to be set up (F2130).

Accordingly, it is possible to determine if relocation of a parity group to be relocated to the destination storage apparatus 20000B is permitted only by specifying the IP address of the source storage apparatus 20000A, the parity group to be relocated, and the IP address of the destination storage apparatus 20000B by a user, and to switch, if the relocation is determined to be permitted, the HDDs that constitute the parity group to be relocated into a write-inhibit state, so that the HDDs are allowed to be removed.

<Process of Attaching the Physical Storage Devices>

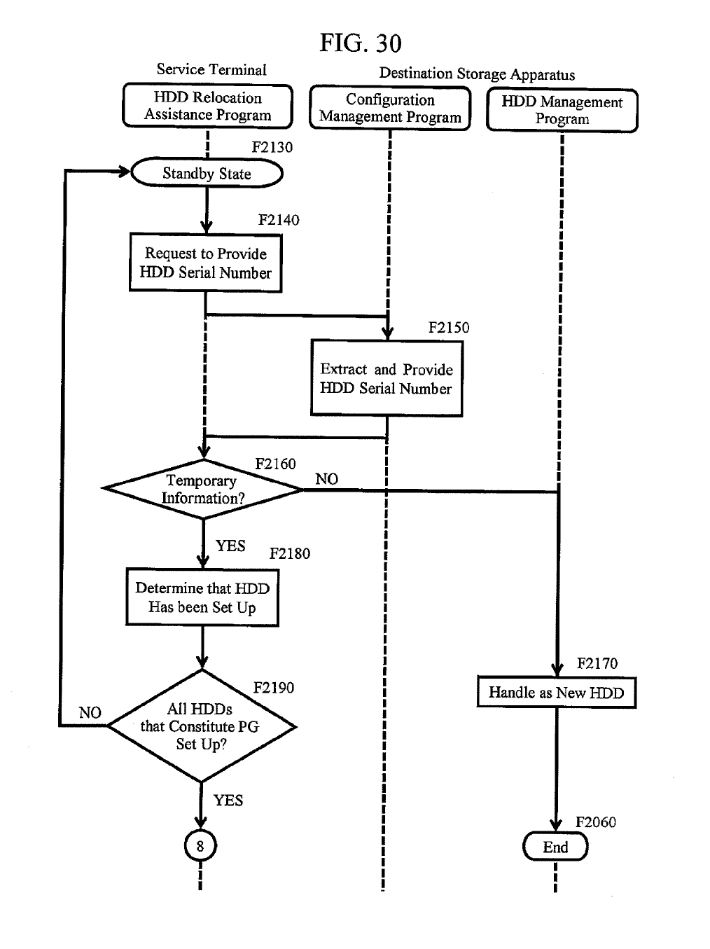

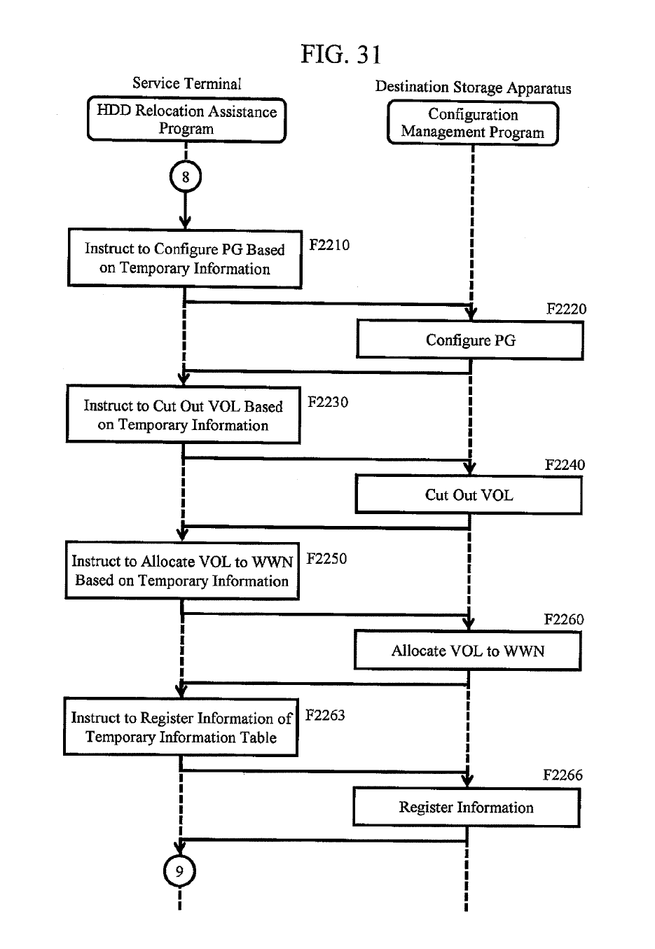

FIG. 30 to FIG. 32 are flowcharts for illustrating a process of setting up the physical storage devices removed from the source storage apparatus 20000A in the destination storage apparatus 20000B.

The HDD relocation assistance program 23210 of the service terminal 40000 periodically inquires of the configuration management program 23220 of the destination storage apparatus 20000B for the presence or absence of a set-up HDD. Upon detecting a set-up HDD, the HDD relocation assistance program 23210 returns from the standby mode (F2130) and requests the configuration management program 23220 to provide information on the serial number of the HDD (F2140).

The configuration management program 23220 extracts the serial number of the HDD, and informs the HDD relocation assistance program 23210 of the extracted serial number (F2150).

Then, the HDD relocation assistance program 23210 checks if the HDD serial number field 23286 of the temporary configuration information table 23280 contains an HDD serial number that matches the received HDD serial number (F2160). If a matching HDD serial number is determined to be absent (if the answer to F2160 is NO), the HDD management program 23230 of the destination storage apparatus 20000B performs the process assuming that the HDD is a newly set-up HDD (F2170), and terminates the process (F2060).

Meanwhile, if the HDD serial number field 23286 of the temporary configuration information table 23280 contains an HDD serial number that matches the serial number of the HDD (if the answer to F2160 is YES), the HDD relocation assistance program 23210 registers “1” in the setup completion field 23287 assuming that the HDD has been set up (F2180), and checks if all values in the setup completion field 23287 of the HDDs that constitute the relevant parity group are “1” (F2190).

If the setup completion field 23287 is determined to contain “0” which indicates the presence of an HDD that has not been set up (if the answer to F2190 is YES), that is, if not all of the HDDs to be relocated have been set up, the process returns to a standby state (F2130).

Meanwhile, if all values in the setup completion field 23287 are determined to be “1” (if the answer to F2190 is YES), that is, if all of the HDDs to be relocated have been set up, the HDD relocation assistance program 23210 instructs the configuration management program 23220 of the destination storage apparatus 20000B to configure a parity group in accordance with the temporary configuration information table 23280 (F2210). In response to this instruction, the configuration management program 23220 configures a parity group (F2220).

Next, the HDD relocation assistance program 23210 instructs the configuration management program 23220 of the destination storage apparatus 20000B to cut a volume out of the parity group in accordance with the temporary configuration information table 23280 and to correlate the volume with the LBA of the HDDs in accordance with the temporary control information table 23290 (F2230). In accordance with such instruction, the configuration management program 23220 cuts out a volume and correlates the volume with the LBA of the HDDs (F2240).

Further, the HDD relocation assistance program 23210 instructs the configuration management program 23220 to allocate the cut-out volume to the WWN of the host computer 10000 in accordance with the temporary configuration information table 23280 (F2250). In accordance with such instruction, the configuration management program 23220 allocates the volume to the WWN (F2260).

Upon completion of a series of the operations from F2210 to F2260, the HDD relocation assistance program 23210 instructs the configuration management program 23220 to register information that is registered in the temporary configuration information table 23280 and the temporary control information table 23290 (F2263). In accordance with such instruction, the configuration management program 23220 registers the information in the control information and configuration information (not shown) that the program itself manages (F2266).

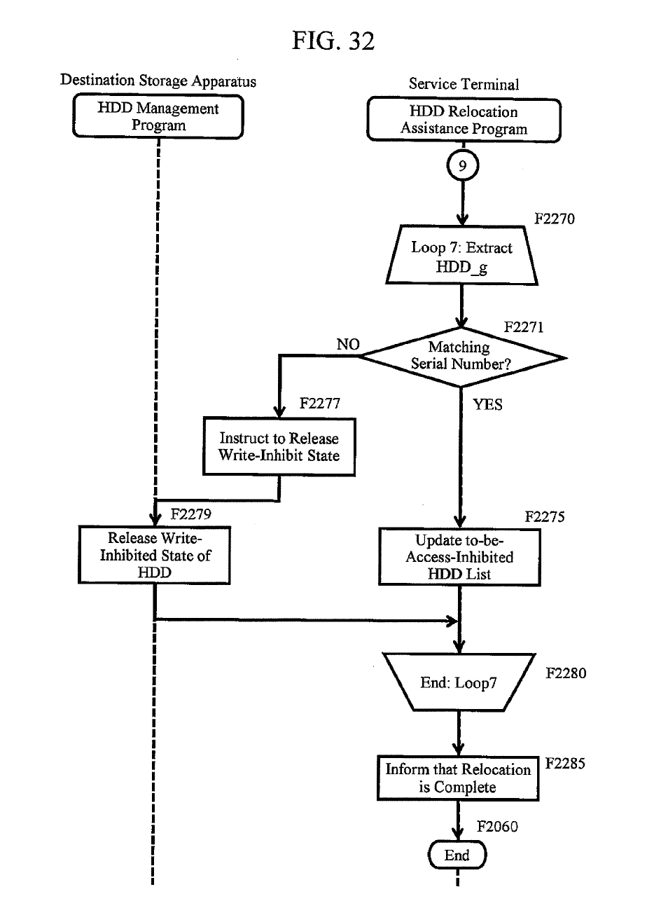

Next, in Loop 7 from F2270 to F2280, the HDD relocation assistance program 23210 performs a process of releasing the write-inhibit state of the HDDs to be relocated or removing the HDDs from the to-be-access-inhibited HDD list (see FIG. 32).

Specifically, the HDD relocation assistance program 23210 extracts an HDD_g to be relocated from the temporary configuration information table 23280 (F2270), and determines if the to-be-access-inhibited HDD list 23270 contains a serial number that matches the serial number of the HDD_g (F2271).

If the to-be-access-inhibited HDD list 23270 is not determined to contain a serial number that matches the serial number of the HDD_g (if the answer to F2271 is NO), the HDD relocation assistance program 23210 instructs the HDD management program 23230 of the destination storage apparatus 20000B to release the write-inhibit state of the HDD (F2277). In accordance with such instruction, the HDD management program 23230 releases the write-inhibit state of the HDD (F2279).

Meanwhile, if the to-be-access-inhibited HDD list 23270 is determined to contain a serial number that matches the serial number of the HDD_g (if the answer to F2271 is YES), the HDD relocation assistance program 23210 deletes the serial number from the to-be-access-inhibited HDD list 23270 (F2275).

Then, assuming that the HDD to be relocated selected in F2270 has been processed, the HDD relocation assistance program 23210 returns the process to step F2270 (F2280). In step F2270, an HDD to be relocated, which is registered in the temporary configuration information table 23280 and is not processed yet, is extracted as the HDD_g, and the process of Loop 7 is executed to all HDDs to be relocated that are registered in the temporary configuration information table 23280.

When Loop 7 is complete, the HDD relocation assistance program 23210 informs the user (administrator) of the completion of the relocation (F2285), and terminates the process (F2060).

Accordingly, a configuration in the source storage apparatus 20000A can be restored only by setting up the HDDs to be relocated in the destination storage apparatus 20000B by a user (administrator).

<Process of Inhibiting the Use of a Reserved Parity Group ID>

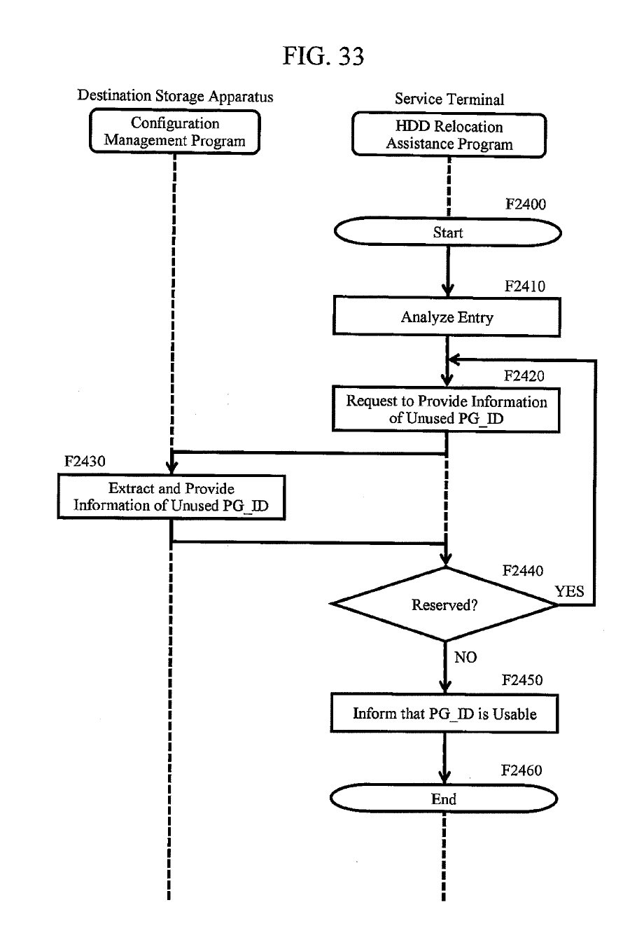

FIG. 33 is a flowchart for illustrating a process in which the HDD relocation assistance program 23210 of the service terminal 40000 inhibits the use of a parity group ID, which has been reserved in the destination storage apparatus 20000B for a parity group to be relocated, for a different purpose in accordance with the second embodiment.

The HDD relocation assistance program 23210 initiates a process of inhibiting the use of the reserved parity group ID upon detecting a request entered by a user (administrator) to generate a new parity group in the destination storage apparatus 20000B, for example (F2400).

Then, the HDD relocation assistance program 23210 analyzes the entry from the user (F2410) and instructs the configuration management program 23220 of the destination storage apparatus 20000B to extract an unused PG_ID and inform the HDD relocation assistance program 23210 of the extracted unused PG_ID (F2420).

The configuration management program 23220 extracts an unused PG_ID and informs the HDD relocation assistance program 23210 of the extracted unused PG_ID (F2430).

Next, the HDD relocation assistance program 23210 compares the PG_ID field 23281 of the temporary configuration information table 23280 with the extracted unused PG_ID (F2440), and, if a matching PG_ID is determined to exist (if the answer to F2440 is YES), returns the process to step F2420.

Meanwhile, if no matching PG_ID is determined to exist (if the answer to F2440 is NO), the HDD relocation assistance program 23210 sends information indicating that the extracted PG_ID is usable to the configuration management program 23220 (F2450), and terminates the process (F2460).

<Process of Inhibiting the Use of a Reserved Volume ID>

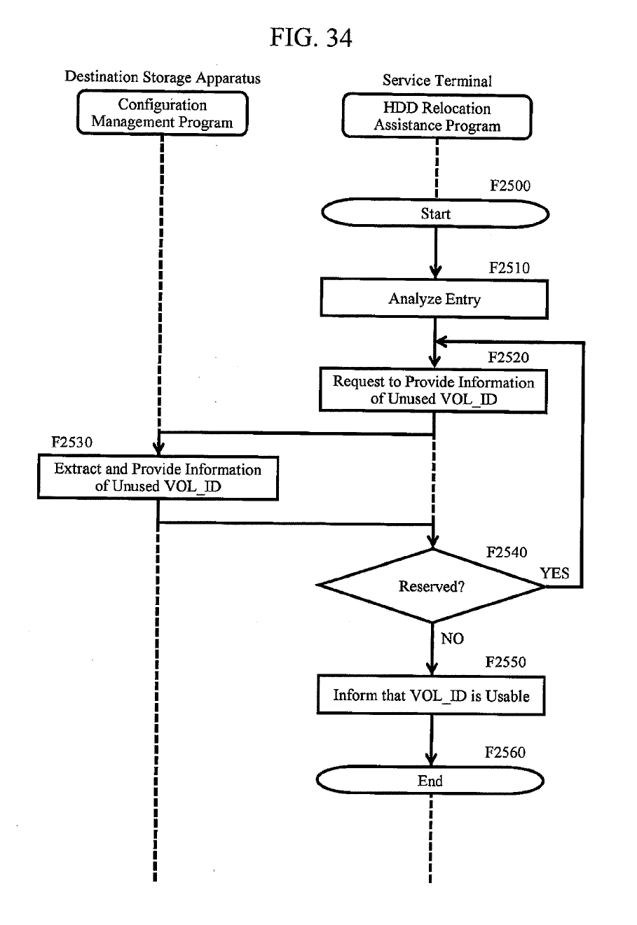

FIG. 34 is a flowchart for illustrating a process in which the HDD relocation assistance program 23210 of the service terminal 40000 inhibits the use of a volume ID, which has been reserved in the destination storage apparatus 20000B for a volume that has been cut out of the parity group to be relocated, for a different purpose in accordance with the second embodiment.

The HDD relocation assistance program 23210 initiates a process of inhibiting the use of the reserved volume ID upon detecting a request entered by a user (administrator) to generate a new volume in the destination storage apparatus 20000B, for example (F2500).

The HDD relocation assistance program 23210 analyzes the entry from the user (F2510), and instructs the configuration management program 23220 of the destination storage apparatus 20000B to extract an unused VOL_ID and inform the HDD relocation assistance program 23210 of the extracted unused VOL_ID (F2520).

The configuration management program 23220 extracts an unused VOL_ID and informs the HDD relocation assistance program 23210 of the extracted unused VOL_ID (F2530).

Next, the HDD relocation assistance program 23210 compares the VOL_ID field 23283 of the temporary configuration information table 23280 with the extracted unused VOL_ID (F2540), and, if a matching VOL_ID is determined to exist (if the answer to F2540 is YES), returns the process to step F2520.

Meanwhile, if no matching VOL_ID is determined to exist (if the answer to F2540 is NO), the HDD relocation assistance program 23210 informs the user that the extracted VOL_ID is usable (F2550), and terminates the process (F2560).

Accordingly, it is possible to prevent the IDs, which are used for the parity group to be relocated and for a volume cut out of the parity group to be relocated, from being used for different purposes, and thus to prevent a circumstance that the physical storage devices would not be able to be relocated.

<GUI for the Relocation Process>

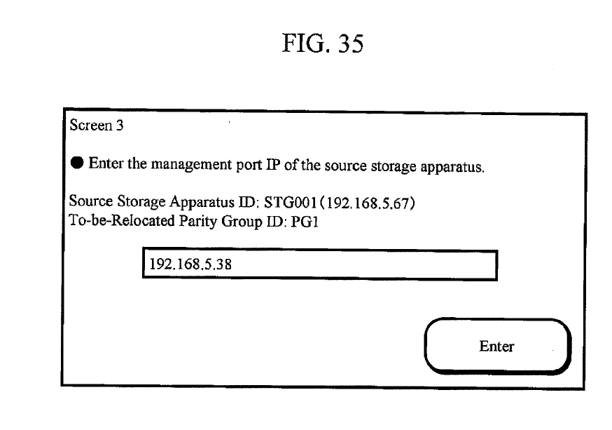

FIG. 35 is a diagram showing an exemplary GUI used to enter the management port IP of the destination storage apparatus 20000B. It should be noted that the screens for entering the management port IP of the source storage apparatus 20000A and selecting a parity group to be relocated are the same as those in the first embodiment (see FIGS. 20 and 21).

When a user (administrator) enters the administrative IP address of the source storage apparatus 20000A via the screen 1 (FIG. 20) and specifies a parity group to be relocated via a screen 2 (FIG. 21), an IP entry screen of the destination storage apparatus 20000B such as a screen 3 (FIG. 35) is displayed. Then, the user enters the management port IP of the destination storage apparatus 20000B. When the management port IP is entered and OK button is pressed, a relocation process is initiated.

### (3) Conclusion

According to the present invention, an HDD relocation assistance program, upon receiving an instruction to initiate a process of relocating a physical storage device from a source storage apparatus to a destination storage apparatus, acquires the configuration information of the logical storage area and the physical storage device in the source storage apparatus, and secures management information (parity group configuration information and volume control information (e.g., correspondence information between the virtual LBA range and the physical LBA range)) of a logical storage area in the destination storage apparatus so that the logical storage area to be relocated can be configured in the destination storage apparatus. Then, the HDD relocation assistance program switches the physical storage device in the source storage apparatus into a write-inhibit state and informs the administrator that the physical storage device is removable from the source storage apparatus. Accordingly, it is possible to safely remove the physical storage device to be relocated from the source storage apparatus. That is, execution of such a process can inhibit data writing to or data deletion from the physical storage device to be relocated, whereby it is possible to prevent data loss even when a write request is issued to the physical storage device with the intention to use the physical storage device for a different purpose or a write request is issued by an operation error.

When attachment of a physical storage device (HDD) to the destination storage apparatus is detected, the HDD relocation assistance program checks if the attached HDD is the physical storage device to be relocated. If the attached HDD is determined to be the physical storage device to be relocated, a logical storage area is generated in the destination storage apparatus using the secured management information (parity group configuration information and volume control information). If the attached HDD is not the physical storage device to be relocated, the attached HDD is handled as a newly attached HDD. Accordingly, it is possible to prevent a resource, which has been secured in the destination storage apparatus for a relocation process to be performed, from being used for a setup process of other HDDs. Thus, it is possible to prioritize a relocation process of a physical storage device to be relocated over a setup process of other HDDs, in terms of the secured resource. Accordingly, a reliable, safe relocation process is ensured.

Further, if the HDD attached to the destination storage apparatus is the physical storage device to be relocated, the physical storage device is switched into a write-enable state after a logical storage area is generated therein. Then, information indicating the completion of the relocation process is issued. Accordingly, data writing to the physical storage device is inhibited until the physical storage device to be relocated is restored in the destination storage apparatus. Thus, the physical storage device to be relocated can be safely attached to the destination storage apparatus.

Further, the storage system (computer system) in accordance with the present invention provides a GUI for specifying a source storage apparatus and a parity group to be relocated. Accordingly, it is possible to easily specify the target to be relocated and provide to an administrator an environment in which the storage system can be easily managed. Alternatively, the GUI can also be configured to specify the destination storage apparatus.

When a request to generate a parity group in the destination storage apparatus is received before issuing the information indicating the completion of the relocation process, the HDD relocation assistance program references the management information (parity group configuration information and volume control information) secured in the destination storage apparatus, determines if the parity group and a volume included therein can be configured in the destination storage apparatus, and executes, only when they are determined to be configurable, a process corresponding to the request to generate a parity group. Thus, it is possible to prevent the information, which has been secured for a physical storage device to be relocated, from being used for generation of other parity groups, and thus to prioritize the processing of the physical storage device to be relocated. Accordingly, a reliable, safe relocation process is ensured.

It should be noted that the present invention can also be realized by a program code of software that implements the functions of the embodiments. In such a case, a storage medium having recorded thereon the program code is provided to a system or an apparatus, and a computer (or a CPU or a MPU) in the system or the apparatus reads the program code stored in the storage medium. In this case, the program code itself read from the storage medium implements the functions of the aforementioned embodiments, and the program code itself and the storage medium having recorded thereon the program code constitute the present invention. As the storage medium for supplying such a program code, for example, a flexible disk, CD-ROM, DVD-ROM, a hard disk, an optical disc, a magneto-optical disc, CD-R, a magnetic tape, a nonvolatile memory card, ROM, or the like is used.

Further, based on an instruction of the program code, an OS (operating system) running on the computer or the like may perform some or all of actual processes, and the functions of the aforementioned embodiments may be implemented by those processes. Furthermore, after the program code read from the storage medium is written to the memory in the computer, the CPU or the like of the computer may, based on the instruction of the program code, perform some or all of the actual processes, and the functions of the aforementioned embodiments may be implemented by those processes.

Moreover, the program code of the software that implements the functions of the embodiments may be distributed via a network, and thereby stored in storage means such as the hard disk or the memory in the system or the apparatus, or the storage medium such as CD-RW or CD-R, and at the point of use, the computer (or the CPU or the MPU) in the system or the apparatus may read the program code stored in the storage means or the storage medium and execute the program code.

### REFERENCE SIGNS LIST

10000 host computer
20000 storage apparatus
20000A source storage apparatus
20000B destination storage apparatus
30000 IP/SAN
35000 management network
40000 service terminal (management computer)

1. A computer system comprising a first storage apparatus having a physical storage device in which data of a logical storage area is stored, a second storage apparatus connected to the first storage apparatus via a network, and a control device configured to manage the first and second storage apparatuses, wherein
the control device performs the following processes:
receiving an instruction to initiate a process of relocating the physical storage device from the first storage apparatus to the second storage apparatus,
acquiring configuration information of the logical storage area and the physical storage device in the first storage apparatus,
securing management information of a logical storage area in the second storage apparatus so that the logical storage area in the first storage apparatus can be configured in the second storage apparatus, and
switching the physical storage device in the first storage apparatus into a write-inhibit state, and thereafter outputting information indicating that the physical storage device is removable from the first storage apparatus.

2. A computer system according to claim 1, wherein
the first storage apparatus is a source storage apparatus and the second storage apparatus is a destination storage apparatus,
the destination storage apparatus includes the control device,
(i) the control device performs the following processes:
displaying on a display device a setup screen for specifying the source storage apparatus and specifying the physical storage device in the source storage apparatus as a logical storage area to be relocated, and receiving an instruction to initiate a relocation process via the setup screen,
securing as the management information parity group configuration information and volume control information for configuring the logical storage area in the destination storage apparatus,
instructing, if the physical storage device has a write-inhibit function, the source storage apparatus to switch the physical storage device into a write-inhibit state, and, if the physical storage device has no write-inhibit function, managing the physical storage device as a write-inhibited physical storage device in the destination storage apparatus, and
outputting information indicating that the physical storage device is removable from the source storage apparatus, and thereafter setting the destination storage apparatus to a standby mode, and
(ii) the control device performs the following processes:
generating, upon detecting attachment of the physical storage device removed from the source storage apparatus to the destination storage apparatus, a logical storage area in the destination storage apparatus using the parity group configuration information and the volume control information secured as the management information, and
switching the attached physical storage device into a write-enable state after the logical storage area is generated in the physical storage device, and thereafter outputting information indicating the completion of the relocation process.

3. A computer system according to claim 1, wherein the control device, upon detecting attachment of the physical storage device, checks if the attached physical storage device is the physical storage device to be relocated from the first storage apparatus, generates, if the attached physical storage device is the physical storage device to be relocated, a logical storage area in the second storage apparatus using the secured management information, and, if the attached physical storage device is not the physical storage device to be relocated, handles the attached physical storage device as a new physical storage device other than the physical storage device to be relocated.

4. A computer system according to claim 3, wherein if the attached physical storage device is the physical storage device to be relocated, the control device generates the logical storage area in attached physical storage device, and thereafter switches the physical storage device into a write-enable state and outputs information indicating the completion of the relocation process.

5. A computer system according to claim 1, wherein
the control device displays on a display device a setup screen for specifying the first storage apparatus as a source storage apparatus and specifying the physical storage device in the first storage apparatus as a logical storage area to be relocated, and receives an instruction to initiate a relocation process via the setup screen.

6. A computer system according to claim 4, wherein the control device, upon receiving a request to generate a logical storage area in the second storage apparatus before issuing the information indicating the completion of the relocation process, references the management information secured in the second storage apparatus, determines if the logical storage area and a volume included therein can be configured in the second storage apparatus, and executes a process corresponding to the request only when the logical storage area and the volume included therein are determined to be configurable in the second storage apparatus.

7. A computer system according to claim 1, further comprising a service terminal for managing the first and second storage apparatuses, wherein the service terminal includes the control device, displays on a display device a setup screen for specifying the first storage apparatus as a source storage apparatus, specifying the physical storage device in the first storage apparatus as a logical storage area to be relocated, and specifying the second storage apparatus as a destination storage apparatus, and receives an instruction to initiate a relocation process via the setup screen.

8. A method for managing a computer system that includes a first storage apparatus having a physical storage device in which data of a logical storage area is stored, a second storage apparatus connected to the first storage apparatus via a network, and a control device configured to manage the first and second storage apparatuses, the method comprising the following steps performed by the control device:
receiving an instruction to initiate a process of relocating the physical storage device from the first storage apparatus to the second storage apparatus;
acquiring configuration information of the logical storage area and the physical storage device in the first storage apparatus;
securing management information of a logical storage area in the second storage apparatus so that the logical storage area in the first storage apparatus can be configured in the second storage apparatus; and
switching the physical storage device in the first storage apparatus into a write-inhibit state, and thereafter outputting information indicating that the physical storage device is removable from the first storage apparatus.

9. A method for managing the computer system according to claim 8, wherein
the first storage apparatus is a source storage apparatus and the second storage apparatus is a destination storage apparatus,
the destination storage apparatus includes the control device,
(i) the control device performs the following steps:
displaying on a display device a setup screen for specifying the source storage apparatus and specifying the physical storage device in the source storage apparatus as a logical storage area to be relocated, and
receiving an instruction to initiate a relocation process via the setup screen,
securing as the management information parity group configuration information and volume control information for configuring the logical storage area in the second storage apparatus,
instructing, if the physical storage device has a write-inhibit function, the source storage apparatus to switch the physical storage device into a write-inhibit state, and, if the physical storage device has no write-inhibit function, managing the physical storage device as a write-inhibited physical storage device in the destination storage apparatus, and
outputting information indicating that the physical storage device is removable from the source storage apparatus, and thereafter setting the destination storage apparatus (20000B) to a standby mode, and
(ii) the control device performs the following steps:
generating, upon detecting attachment of the physical storage device removed from the source storage apparatus to the destination storage apparatus, a logical storage area in the destination storage apparatus using the parity group configuration information and the volume control information secured as the management information, and
switching the attached physical storage device into a write-enable state after the logical storage area is generated in the physical storage device, and thereafter outputting information indicating the completion of the relocation process.

10. A method for managing the computer system according to claim 8, wherein the control device, upon detecting attachment of the physical storage device, checks if the attached physical storage device is the physical storage device to be relocated from the first storage apparatus, generates, if the attached physical storage device is the physical storage device to be relocated, a logical storage area in the second storage apparatus using the secured management information, and, if the attached physical storage device is not the physical storage device to be relocated, handles the attached physical storage device as a new physical storage device other than the physical storage device to be relocated.

11. A method for managing the computer system according to claim 10, wherein if the attached physical storage device is the physical storage device to be relocated, the control device generates the logical storage area in the attached physical storage device, and thereafter switches the physical storage device into a write-enable state and outputs information indicating the completion of the relocation process.

12. A method for managing the computer system according to claim 8, wherein the control device displays on a display device a setup screen for specifying the first storage apparatus as a source storage apparatus and specifying the physical storage device in the first storage apparatus as a logical storage area to be relocated, and receives an instruction to initiate a relocation process via the setup screen.

13. A method for managing the computer system according to claim 11, wherein the control device, upon receiving a request to generate a logical storage area in the second storage apparatus before issuing information indicating the completion of the relocation process,
references the management information secured in the second storage apparatus, determines if the logical storage area and a volume included therein can be configured in the second storage apparatus, and executes a process corresponding to the request only when the logical storage area and the volume included therein are determined to be configurable in the second storage apparatus.

14. A method for managing the computer system according to claim 8, wherein
the computer system further includes a service terminal for managing the first and second storage apparatuses, and
the service terminal includes the control device, displays on a display device a setup screen for specifying the first storage apparatus as a source storage apparatus, specifying the physical storage device in the first storage apparatus as a logical storage area to be relocated, and
specifying the second storage apparatus as a destination storage apparatus, and receives an instruction to initiate a relocation process via the setup screen.
